(19) United States
(12) Patent Application Publication
(10) Pub. No.: US 2026/0323417 A1
(43) Pub. Date: Oct. 15, 2026

(54) APPARATUS AND METHOD FOR HANDLING HANDOVER OF UE IN WIRELESS NETWORK

(71) Applicant: Samsung Electronics Co., Ltd., Suwon-si (KR)

(72) Inventors: Vivek MURUGAIYAN, Bangalore (IN); Sidhant JAIN, Bangalore (IN); Nishant, Bangalore (IN); Kailash Kumar JHA, Bangalore (IN); Amit Anandrao DANGE, Bangalore (IN)

(21) Appl. No.: 19/648,599

(22) Filed: Apr. 15, 2026

Related U.S. Application Data
(63) Continuation of application No. PCT/KR2026/095902, filed on Apr. 14, 2026.

(30) Foreign Application Priority Data
Apr. 15, 2025 (IN) 202541036382
Mar. 25, 2026 (IN) 2025 41036382

(51) Int. Cl. H04W 36/00; H04W 36/36

(52) U.S. Cl. CPC H04W 36/0069; H04W 36/0058; H04W 36/362

(57) ABSTRACT

A method for handling a handover of a user equipment (UE) in a wireless network is provided. The method includes receiving a layer trigger mobility (LTM) configuration message to perform a master cell group (MCG) cell change from a first network entity. The method includes receiving a secondary cell group (SCG) addition message from the first network entity. The SCG addition message includes at least one of a primary secondary cell (PSCell) addition configuration and a conditional PSCell addition (CPA) associated with the PSCell addition configuration, a configuration for PSCell addition and a LTM execution condition associated with the configuration, and a configuration for PSCell addition and a conditional LTM execution condition associated with the configuration. The method includes measuring and sending an MCG measurement report for handover and stopping a measurement event and execution of the associated SCG cell. The method includes performing the handover of the UE to a second network entity based on handover information.

### CROSS REFERENCE TO RELATED APPLICATION

This application is a continuation application, claiming priority under 35 U.S.C. § 365(c), of an International application No. PCT/KR2026/095902, filed on Apr. 14, 2026, which is based on and claims the benefit of an Indian Provisional patent application number 202541036382, filed on Apr. 15, 2025, in the Indian Patent Office, and of an Indian Complete patent application number 202541036382, filed on Mar. 25, 2026, in the Indian Patent Office, the disclosure of each which is incorporated by reference herein in its entirety.

### TECHNICAL FIELD

The disclosure relates to a wireless communication network. More particularly, the disclosure relates to a method for handling measurements to avoid secondary cell group (SCG) addition/removal ping-pong during layer 1 (L1)/layer 2 (L2) triggered mobility (LTM) handover in the wireless communication network.

### BACKGROUND

Conditional PSCell addition (CPA)/conditional secondary cell group (SCG) is introduced in which a user equipment (UE) has to do measurement evaluation for SCG addition for candidate cells configured in conditional reconfiguration and the UE performs SCG addition once evaluation criteria are satisfied. A layer 1 (L1)/layer 2 (L2) triggered mobility (LTM) is introduced in Release 18 specification and a network configures candidate cells configuration and the UE performs the measurements for an LTM candidate cell. The UE triggers L1 level measurement report to an gNB and the gNB triggers handover to LTM candidate cell through a medium access control control-element (MAC CE). A conditional LTM (C-LTM) is agreed to be introduced in Release 19 RAN standards for MCG change and it is obvious that it will be extend for SCG addition/change in further releases. The LTM is also applicable for SCG addition and the UE sends L1 level measurement report to the gNB for SCG candidate cell and the gNB triggers SCG addition through the MAC CE.

Based on RAN meetings, 3GPP RAN 2 agreed that LTM events and CHO event configuration can co-exist at same time in the UE and several discussion are ongoing on the problem during co-existence. As per 3GPP Specification 38.331, “UE may receive two independent conditional Reconfiguration events (e.g., conditional reconfiguration for MCG and SCG independently) and UE may receive two independent ltm-Config (LTM configuration for MCG and SCG independently)”. It is agreed that 3GPP Release 19 specifications introduces LTM conditional events for LTM based handover and SCG cell addition/change and the UE will send LTM measurement report to the network only when event gets satisfied and so that the network provide cell switch/addition through MAC CE based on measurement event.

With the introduction of LTM in 3GPP Release 18 specifications and RAN2 meeting #126 Agreements, the network can provide LTM and CHO events configurations at same time. Co-existence of multiple conditional events (e.g., CHO, CPA, CPC) and LTM events (LTM handover and LTM SCG addition) are possible at same time. So, the network can provide SCG addition configuration and MCG change at same time to be performed through CHO and LTM events.

As of now, the 3GPP specification doesn't restrict or define any process for prioritizing the measurements of the different events (e.g., MCG Change or SCG addition or the like). So, these measurements corresponding to MCG change and SCG addition can happen simultaneously in the UE. It is possible that the event for the MCG change (Ex, LTM event) gets satisfied before SCG addition event (conditional LTM event/LTM event/both) is satisfied. In such cases, the UE will send LTM L1 measurement report of MCG to the network and it will wait for LTM handover MAC CE command. Further, the UE will continue to perform the CPA based SCG addition condition evaluation while waiting for MAC CE command for LTM Handover.

So, the UE may satisfy the SCG CPA condition and it may get LTM handover command at the same time. It may lead to longer bearer modification time and can lead to fluctuations in throughput during the execution of these two processes. This existing method causes overhead measurement by the UE and wastage of network resources takes place as UE added SCG momentarily and gets removed due to MCG change. As specification does not specify any measures for these scenarios.

FIG. 1 is an example diagram illustrating the UE 202 sending measurement report for LTM handover event, while LTM/CPA/C-LTM configuration is used for SCG addition, according to the related art. The UE 202 keeps measuring measurement of LTM/CLTM/CPA event for SCG addition. This leads to addition of SCG momentarily and SCG will be removed immediately on handover command as response to L1 measurement report.

FIGS. 2A and 2B are example flow diagrams illustrating CHO and SCG addition through CPA, according to the related art.

Referring to FIGS. 2A and 2B, in operation 2-1, the UE 202 receives a rrcReconfiguration including CHO configuration from a source gNB 204. In operation 2-2, and operation 2-3, the UE 202 on receiving the CHO configuration from the source gNB 204, the UE 202 sends a rrcReconfigurationComplete to the source gNB 204 and performs measurements for conditions associated with CHO. In operation 2-3A, the UE 202 performs CHO condition evaluation. In operation 2-3B, e.g., if CHO associated conditions are met, lose source gNB (e.g., UE 202 releases the source gNB connection), and performs the downlink (DL) synchronization with a target PCell. In operation 2-4, the UE 202 applies target CHO configuration and performs RACH (up link synchronization), and in operation 2-5, the rrcReconfiguration is completed with the target PCell (MCG candidate) 206. In operation 2-6, the target PCell (e.g., MCG candidate cell) 206, sends the rrcReconfiguration e.g., CPA candidate configuration with execution condition to the UE 202. In operation 2-7, the UE 202 sends the rrcReconfigurationComplete to the target PCell. In operation 2-8, the UE 202 performs measurements for conditions associated with CPA. In operation 2-9, the UE 202 again evaluates CPA condition. In operation 2-10, if the CHO associated conditions are met, the UE 202 performs DL synchronization with the target Scell (SCG candidate cell) 208. Finally in operation 2-11, the UE 202 applies target CPA configuration and performs RACH (UL synchronization) and SCG gets added.

Referring to FIGS. 2A and 2B, the CHO introduced in the 3GPP Release 16 specification, enables the handover of the MCG cell connection from the serving cell to the target cell. In the CHO, the network/gNB sends the RRC reconfiguration message with a list of CHO candidate cells and the associated execution conditions. The UE 202 applies the candidate cell configuration and performs the RACH to hand over to the selected cell once the associated execution condition is satisfied. In CPA, the gNB provides a list of candidates SCell(s) (SCG candidate cells) and sends reconfiguration message with the list. The network provides the associated execution condition for each of the candidate SCell(s). The UE 202 performs measurements on the candidate cells as per the associated execution conditions. Once the execution condition associated with the candidate cell is satisfied, the UE 202 applies the candidate cell configuration for CPA and SCG is added for the UE 202.

The CPA/SCG configuration as per 3 GPP 38.331 Release V18.0.0 is provided as below:

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) |

OF MeasId

| | |
|---|---|
| condRRCReconfig-r16 | OCTET STRING |

```
(CONTAINING RRCReconfiguration
    ...,
    [[
```

| | |
|---|---|
| condExecutionCondSCG-r17 | OCTET STRING |

(CONTAINING CondReconfigExecCondSCG-r17) OPTIONAL ]],
[[

| | |
|---|---|
| condExecutionCondPSCell-r18 | SEQUENCE (SIZE (1..2)) |

OF MeasId

| | |
|---|---|
| subsequentCondReconfig-r18 | SubsequentCondReconfig-r18 |
| securityCellSetId-r18 | SecurityCellSetId-r18 |
| scpac-ConfigComplete-r18 | ENUMERATED {true} |

```
    ]]
  CondReconfigExecCondSCG-r17 ::= SEQUENCE (SIZE (1..2)) OF
MeasId
  }
```

The condExecutionCond is the execution condition that needs to be fulfilled in order to trigger the execution of a conditional reconfiguration for CHO, CPA, intra-SN CPC without MN involvement, or MN initiated inter-SN CPC. When configuring 2 triggering events (Meas Ids) for a candidate cell, the network ensures that both refer to the same measObject. For CPA and for MN-initiated inter-SN CPC, the network only indicates MeasId(s) associated with condEventA4. For intra-SN CPC, the network only indicates MeasId(s) associated with condEventA3 or condEventA5.

The condExecutionCondSCG-r17 contains execution condition that needs to be fulfilled in order to trigger the execution of a conditional reconfiguration for SN initiated inter-SN CPC, SN initiated inter-SN subsequent CPAC, or SN initiated intra-SN subsequent CPAC with MN involvement. The Meas Ids refer to the measConfig associated with the SCG. When configuring 2 triggering events (Meas Ids) for a candidate cell, network ensures that both refer to the same measObject. For each condReconfigId, the network always configures either condExecutionCond or condExecutionCondSCG (not both). The network only indicates MeasId(s) associated with condEventA3 or condEventA5. The condRRCReconfig contains the RRC Reconfiguration message to be applied when the condition(s) are fulfilled.

FIG. 3 is an example flow diagram illustrating various operations involved in LTM preparation, LTM cell switch execution, and LTM SCG addition execution, according to the related art. To reduce time for measurements and interruption time for handover, L1/L2 Triggered Mobility (LTM) is introduced in Release 18.

Referring to FIG. 3, during the LTM handover, the UE 202 performs the measurements for LTM candidate cell, in operation 3-1, the UE 202 sends measurement report to the gNB 204A at L1 level. The LTM candidate preparation is performed at gNB 204A in operation 3-2A, wherein in operation 3-2B, the rrcReconfiguration (LTM candidate cell configuration) is sent to the UE 202. In operation 3-3, the UE 202 sends the rrcReconfiguration complete to the gNB 204A.

In operation 3-4A, the UE 202 send the L1 measurement report to the gNB 204, where the gNB 204A, in operation 3-4B, performs LTM decision, and in operation 3-5, the cell switch command with the MAC CE is sent to the UE 202 from the gNB 204A. The gNB 204A triggers handover to the LTM candidate cell through the MAC CE, thereby making the cell switch many times faster in LTM in comparison with legacy HO and conditional handover. Therefore, in operation 3-6, the UE 202 detaches from the source, apply target configuration during LTM Cell switch execution. Finally, in operation 3-7, the RACH procedure is executed.

In operation 3-8, the L1 measurement report is sent to the gNB 204A, wherein, in operation 3-9, the LTM SCG addition is decided. Further, in operation 3-10, in LTM, the SCG addition is introduced. Once the UE 202 performs measurements for LTM candidate cell for SCG addition, the UE 202 sends L1 measurement report to the gNB 204A. Once UE 202 sends L1 level measurement report to the gNB 204A, the gNB 204A triggers the SCG addition through MAC CE. Therefore, in operation 3-11, the RACH procedure is performed with gNB 204B.

The LTM candidate cell configuration as per 3 GPP 38.331 Release V18.0.0 is provided as below:

LTM-Config-r18 ::= SEQUENCE {

| | |
|---|---|
| ltm-ReferenceConfiguration-r18 | SetupRelease |

{ReferenceConfiguration-r18}

| | |
|---|---|
| ltm-CandidateToReleaseList-r18 | SEQUENCE |

(SIZE (1..maxNrofLTM-Configs-r18)) OF LTM-CandidateId-r18

| | |
|---|---|
| ltm-CandidateToAddModList-r18 | SEQUENCE |

```
(SIZE (1..maxNrofLTM-Configs-r18)) OF LTM-Candidate-r18
          ...
          attemptLTM-Switch-r18
ENUMERATED {true}
```

| | |
|---|---|
| ltm-ServingCellUE-MeasuredTA-ID-r18 | INTEGER |
| (1..maxNrofLTM-Configs-r18-plus-1) | OPTIONAL, -- Cond LTM |

```
              ...
          }
```

| | |
|---|---|
| LTM-Candidate-r18 ::= | SEQUENCE { |
| ltm-CandidateId-r18 | LTM-CandidateId-r18, |
| ltm-CandidatePCI-r18 | PhysCellId, |
| ltm-SSB-Config-r18 | LTM-SSB-Config-r18 |
| ltm-CandidateConfig-r18 | OCTET STRING |

(CONTAINING RRCReconfiguration)

| | |
|---|---|
| ltm-ConfigComplete-r18 | ENUMERATED {true} |
| ltm-EarlyUL-SyncConfig-r18 | SetupRelease { EarlyUL- |

SyncConfig-r18 }

| | |
|---|---|
| ltm-EarlyUL-SyncConfigSUL-r18 | SetupRelease |

{ EarlyUL-SyncConfig-r18
...

| | |
|---|---|
| ltm-NoResetID-r18 | INTEGER (1..maxNrofLTM- |

Configs-r18-plus-1)

| | |
|---|---|
| ltm-UE-MeasuredTA-ID-r18 | INTEGER (1..maxNrofLTM- |

Configs-r18-plus-1)
}

ltm-CandidateToAddModList defines the list of LTM candidate configuration to add and/or modify. Ltm-CandidateId defines the field indicates an LTM candidate configuration. ltm-CandidateConfig defines the field that includes an RRCReconfiguration message used to configure an LTM candidate cell. Itm-CandidatePCI defines the field identifies the PCI of the SpCell of the configuration contained in ltm-CandidateConfig.

During RAN2 Working Group meeting for Work Item NR Mobility Enhancement Phase 4 for Release 19, support for the LTM measurement events based on beam specific quality of serving cell and candidate cells is agreed. That is The “Event LTM2” specifies the beam of serving cell becomes worse than absolute threshold. “Event LTM3” specifies the beam of candidate cell becomes amount of offset better than beam of serving cell. “Event LTM4” specifies the beam of candidate cell becomes better than absolute threshold. “Event LTM5” specifies the beam of serving cell becomes worse than absolute threshold1 and beam of candidate cell becomes better than another absolute threshold2. Hence, the agreements add the enhancements in LTM configuration and adds the credibility in L1/L2 triggered mobility. As events are added from release-19 along with candidate cells configuration, sending measurement report after LTM events condition gets satisfied to robustness and high chance for receiving response from the network through MAC CE command to perform MCG cell change or SCG cell addition/change.

Conditional LTM (C-LTM) is agreed to be introduced in Release 19 RAN standards (RP-242356) under the study item NR_Mob_Ph4. During conditional LTM handover, the network provides the UE 202 with LTM configurations and associated LTM events. The UE 202 performs the measurements for the LTM events and applies the configuration to move to the target MCG cell upon successful evaluation of event.

Agreements on C-LTM in 3GPP RAN WG, wherein the triggering condition of conditional LTM can be based on L3 measurement and CondEventA3 and CondEventA5 conditions can be baseline for the conditional LTM execution. The L1 execution condition of a candidate cell is associated to only one triggering event. For L3 execution condition, it may consist of one or two triggering condition(s). If there are two triggering conditions associated with the same candidate cell, the UE 202 shall consider the execution condition is fulfilled only when both triggering conditions are met. Only single RS type is supported and at most two different trigger quantities can be configured simultaneously for the evaluation of execution condition of a single candidate cell.

For L1-based conditional LTM the condition evaluation is at MAC level and for L3-based conditional LTM the condition evaluation is at RRC level. With agreement of conditional LTM and subsequent conditional LTM for MCG cell change (handover) in release-19, conditional LTM event will be extended to support for SCG addition in subsequent releases.

With introduction of LTM in 3GPP Release 18 and RAN 2 Agreement of existence of LTM and CHO events configuration at same time in UE 202, co-existence of multiple conditional events (CHO, CPA, CPC) and LTM events (LTM handover and LTM SCG addition) are possible at same time. Based on RAN2 meetings #126, standards agreed that LTM events and CHO event configuration can co-exist at same time in UE 202 and several discussions are ongoing on the problem during co-existence.

C-LTM is agreed to be introduced in Release 19 RAN standards for MCG and it is obvious that it will be extend for SCG in further releases. As per 3GPP Specification 38.331, “the UE 202 may receive two independent conditional Reconfiguration events (conditional reconfiguration for MCG and SCG independently) and the UE 202 may receive two independent ltm-Config (LTM configuration for MCG and SCG independently)”.

Further, the RAN2 standards has agreed that 3GPP Release 19 specifications introduces LTM conditional events for LTM based handover and SCG cell addition/change. The UE 202 will send LTM measurement report to network only when event gets satisfied and so network provide cell switch/addition through MAC CE based on measurement event. The network can configure UE 202 with SCG addition configurations and MCG change events at same time. Basically, CHO and LTM events for SCG addition and handover can be configured simultaneously.

As of now, the 3GPP specification doesn't specify any method or specific details on prioritizing measurement of the different events (e.g., MCG change or SCG addition) and so measurements for MCG change and SCG addition can be happen simultaneously in the UE 202. Measurement for MCG (for example, LTM event) can get satisfied before SCG event (CPA or LTM event or C-LTM) gets satisfied and the UE 202 will send L1 measurement event report of MCG (LTM event) to the network and will wait for MAC CE command of handover. 3GPP specification doesn't specify any measures to the mentioned scenario. So, the UE 202 will keep measuring condition evaluation of SCG candidate cell (CPA/LTM event/C-LTM) while waiting for MAC CE command for handover.

The SCG will get added through CPA condition evaluation or LTM events or conditional LTM events due to continuous measurement of SCG while waiting for MAC CE command for handover. On receiving handover from the network by MAC CE command as a result of L1 measurement report of MCG (LTM event), the UE 202 will perform handover to target candidate cell and SCG leg will be removed. Thereby, this lead to measurement overhead in the UE 202 and wastage of network resources takes place as the UE 202 added SCG momentarily and gets removed due to MCG change.

For an example, consider a scenario where the network configures the UE 202 with LTM event for MCG cell change (handover) and CPA conditional events or conditional LTM events for SCG cell addition. Once the LTM event for MCG cell change is fulfilled, the UE 202 sends measurement report to gNB waiting for handover command. Meanwhile, as CPA/C-LTM configuration is present, UE 202 keeps measuring condition evaluation for SCG cell addition. The UE 202 will add SCG once CPA/C-LTM conditional events get satisfied.

Similarly, in an instance, consider the scenario where the network configures the UE 202 with LTM event for MCG cell change (handover) and another LTM event for SCG cell addition. Once the LTM event for MCG cell change is fulfilled, the UE 202 sends measurement report to gNB waiting for handover command. Meanwhile, the UE 202 un-necessarily keeps performing measurements for LTM event for SCG cell addition and sends measurement report for SCG addition when SCG events gets satisfied. In both the scenarios above, even if SCG measurement is fulfilled and the UE 202 (for CPA) or network (for LTM SCG addition) adds the SCG, the UE 202 will lose the SCG cell as soon as MCG cell change comment (handover) command is received from network. Hence, the existing method leads to sudden drop-in data activity and can leads to packet loss due to change in data path configuration in the UE 202 and leads to instable data activity in the UE 202 and affects user experience.

FIG. 4A is an example diagram illustrating the interaction of various layers for bearer reset upon SCG addition and handover, according to the related art. The UE 202 continues to measure SCG candidate leads to SCG addition and so data gets split between MCG layers and SCG layer. The UE 202 sends the handover command through the MAC CE based on L1 report transmitted. On Handover, the SCG leg gets removed and so again data transmitted in MCG leg only which leads to fluctuation in data transmission.

FIG. 4B is an example graph diagram illustrating the throughput spike followed by a sharp drop, causing a data path instability caused by momentary SCG addition, according to the related art. The UE 202 is connected to the MCG, with no SCG added, and data activity is occurring only on the MCG leg. The UE 202 performs LTM measurements for MCG change and LTM/CPA measurements for SCG addition, and sends an L1 report for the MCG change. The SCG is added due to measurements of the SCG candidate cell, even after the L1 report for the MCG change has been transmitted. The UE's data path is reconfigured as data is split between the MCG and SCG legs, resulting in increased throughput. The handover is triggered as a result of the L1 report transmitted for the MCG change. The SCG leg is then removed, and the UE's data path is reconfigured back to MCG only, causing a drop in throughput. Therefore, the momentary SCG addition leads to uneven data fluctuations, negatively affecting the user experience.

In RAN2 meetings, it has been agreed that LTM handover will be supported along with network-controlled L3 handover. During the RAN2 #124 meeting and RAN2 #125 meeting, several representatives discussed the co-existence of LTM and CHO (R2-2312373, R2-2401379, R2-2400956, R2-2400441, R2-2400184). In legacy L3 handovers, the control and trigger lie with the network. However, in CHO, CPA, and CPAC, the control and trigger lie with the UE 202, meaning these are UE-triggered mobility procedures based on pre-configured execution conditions. In addition, Release 18 introduces CHO enhancements, such as CHO with multiple SCG configurations and subsequent CPAC. These features could be configured with LTM, potentially leading to additional issues. RAN2 began discussions on this matter, and it was agreed during the RAN2 #126 meeting and the RAN2 #127 meeting that CHO can co-exist with Inter-CU LTM scenarios. Several proposals for further scenarios are currently under discussion (R2-2405094, R2-2406819).

During R2-2406819, wherein the Rel-18 intra-CU LTM, the following items has been supported for the coexistence of intra-CU LTM and L3 Mobility, for L3 HO. L3 handover may happen while LTM is configured/evaluated/used for CHO. While configured with LTM configurations, the UE 202 can also be configured with CHO. Before any CHO execution condition is satisfied, upon reception of LTM cell switch command MAC CE, the UE 202 executes the LTM cell switch procedure.

As per 3GPP TS 38.331, the network can provide a ConditionalReconfiguration associated with the SCG for SCG cell addition and a CHO configuration for MCG change in parallel. Similarly, the LTM configuration for MCG change and SCG addition/change can be configured independently.

Conditional Reconfiguration: The network configures the UE 202 with one or more candidate target SpCells in the conditional reconfiguration. The UE 202 evaluates the condition of each configured candidate target SpCell. The UE 202 applies the conditional reconfiguration associated with one of the target SpCells which fulfils associated execution condition.

In NR-DC, the UE 202 may receive two independent conditionalReconfiguration:
a conditionalReconfiguration associated with MCG, which is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

LTM configuration: The network configures the UE 202 with one or more LTM candidate configurations within the LTM-Config IE.

In NR-DC, the UE 202 may receive two independent ltm-Config:
an ltm-Config associated with the MCG that is included within an RRCReconfiguration message received via SRB1; and
an ltm-Config associated with the SCG that is included within an RRCReconfiguration message either received via SRB3, or, alternatively, embedded in an RRCReconfiguration message received via SRB1.

With the introduction of L1/L2 triggered mobility (LTM) in Release 18 and the RAN2 agreement on the coexistence of LTM and CHO events configurations in the UE 202, the network may configure the UE 202 with CHO, conditional PSCell addition (CPA), and conditional PSCell addition change (CPC) configurations, along with their associated execution conditions, together with LTM events for handover and SCG addition.

Consider a scenario, where the UE 202 is connected to the MCG cell and no SCG cell is connected. The network can provide the SCG configuration along with execution conditions for the SCG addition, and the conditional SCG events can be configured independently of other configurations and events. The network can configure the LTM events for MCG change (handover) in the UE 202 at the same time as conditional SCG events for SCG addition. The UE 202 can perform measurements for both events independently.

Hence, the LTM event for the MCG change (handover) can be fulfilled before the SCG conditional event is satisfied. In such a case, the UE 202 sends an L1 measurement report to the gNB and waits for the gNB to trigger the handover to the LTM candidate cell through the MAC CE. Since the 3GPP specification does not restrict SCG measurements for conditional events after the UE 202 sends the LTM measurement report for MCG change, the UE 202 continues measuring the SCG candidate cell for the SCG addition. Once the SCG conditional event is satisfied, the UE 202 applies the CPA configuration and adds the SCG while still waiting for the LTM handover command. Further, the gNB can send the L1 handover command through the MAC CE in response to the L1 measurement report, and the UE 202 hands over to the target cell. The SCG connection, which was just added by the UE 202 through CPA configuration, is lost. Therefore, the existing method results in unnecessary UE measurements and network resource wastage, as the SCG is only momentarily added and removed due to the MCG change.

The UE 202 may experience a data stall or a temporary drop-in data rate, as PDCP and RLC may be re-established upon SCG addition and the data split ratio is reset. Such behavior leads to unnecessary power consumption due to redundant SCG measurements and can cause drop-in data rate due to L2 data path reconfiguration, negatively impacting the user experience.

FIG. 5A is an example sequence diagram wherein the UE 202 handles the coexistence of conditional SCG addition and LTM MCG change, according to the related art.

Referring to operation 5-1, of the sequence diagram, the UE 202 (e.g., RRC 202A and L1 202B) is connected to gNB1 210A of a Cell A 210. In operation 5-2, the source gNB (gNB1 210A) configures the UE 202 with LTM measurement events for MCG handover to target cell-B 212 (gNB3 212A), and in operation 5-3, the UE 202 configures CPA for SCG addition (cell-A 210, gNB2 210B). In operation 5-4A, the UE 202 measures CPA associated execution condition that applies target cell configuration once execution condition is satisfied, the UE 202 sends measurement report for Pcell change in operation 5-4, but in operation 5-4B, the UE 202 keeps measuring CPA execution condition even after sending measurement report for the handover. In operation 5-5A, the CPA condition is satisfied and the UE 202 applies the CPA configuration in operation 5-5. At operation 5-5B, the UE 202 adds SCG based on CPA condition fulfilment but due to LTM handover SCG cell is lost soon after. The UE 202 un-necessarily performs signaling and data paths are re-established for a brief period.

At operation 5-6, the gNB1 210A sends the MAC CE for “handover to target cell” to the L1 of the UE 202. At operation 5-7, the UE 202 handovers to the target Cell-B gNB3 and SCG cell is lost. At operation 5-8, the UE 202 hands over to the target cell based on the MAC CE.

FIG. 5B is an example flow diagram 500 illustrating the co-existence of conditional SCG addition and LTM MCG change in the UE 202, according to the related art.

Referring to operation 502, the UE 202 is connected to gNB 204, wherein the gNB 204 is configured to the LTM events for handover and CPA events for candidate cells and associated execution conditions. In operation 504, the UE 202 performs measurements for LTM events for handover and evaluated CPA associated conditions. In operation 506, the LTM event for handover is satisfied and the UE 202 sends measurement report to the gNB 204 for handover. The UE 202 evaluates CPA associated execution condition. In operation 508, the UE 202 evaluates whether the CPA associated execution condition is satisfied or not. On satisfying the condition in operation 512, the UE 202 applies CPA configuration once associated execution condition is satisfied and SCG is added. The UE re-established PDCP/RLC for SCG addition and splits data between MCG and SCG. In operation 510, the UE 202 keeps evaluating CPA associated execution condition. Further, in operation 514, the gNB triggers handover of UE 202 to target cell and the UE 202 moves to new gNb. Further, added SCG cell is lost in the UE data path and switches to MCG again.

Therefore, the UE 202 unnecessarily evaluates the CPA execution event and adds the SCG cell upon completion of the evaluation, even after sending the LTM measurement event for the MCG and while waiting for the handover command from the network. The UE 202 is handed over to the target cell, causing all SCG events to become overhead, and the added SCG cells are lost.

FIG. 6 is an example time sequence diagram illustrating the UE 202 configured with the LTM for MCG handover, according to the related art.

Referring to FIG. 6, the UE 202 sends measurement report for LTM handover event, wherein the UE 202 is configured with the LTM for handover measurement. Also, the UE 202 continues measuring CPA conditions for SCG addition even after sending the LTM measurement report. Thus, resulting in a period where the SCG is added before the handover command is received. Once the handover is executed, the SCG is removed, causing unnecessary signaling, transient data path changes, and potential throughput instability.

L1/L2 triggered mobility (LTM) was introduced in the Release 18 specification and, as per 3GPP Specification 38.331V 18.1.0 , “the UE 202 may receive two independent ltm-Config instances (LTM configuration for MCG and SCG independently)” and maintain both events simultaneously.

Consider a scenario where the UE 202 is connected to the MCG cell with no SCG cell added. The network can configure the UE 202 with LTM events for handover (e.g., Event LTM3) and LTM events for SCG addition (e.g., Event LTM4), along with their respective configurations, at the same time. The UE 202 stores both configurations and performs L1 measurements for both MCG and SCG candidate cells.

It is possible that the LTM event for the MCG cell change/handover (event LTM3) is fulfilled before the SCG LTM event (Event LTM4) is satisfied. In this case, the UE 202 sends the L1 measurement report to the gNB 204 and waits for the gNB 204 to trigger the handover to the LTM candidate cell through the MAC CE. The 3GPP specification does not restrict LTM measurements for the SCG after the UE 202 sends the LTM measurement report for the MCG change, so that the UE 202 continues to perform L1 measurements of SCG candidate cells for SCG addition.

3GPP specification doesn't restrict measurements of LTM events of SCG after the UE 202 sends LTM measurement report for MCG change and the UE 202 keeps performs L1 measurement of SCG candidate cell for SCG addition. The LTM Event for SCG addition can gets satisfied and the UE 202 sends a measurement report of event (LTM4) even when waiting for MAC CE for handover to target cell. The LTM event for SCG addition can be intra-CU gNB but LTM event for handover can be Inter-CU gNB (LTM events of Inter-CU gNB gets introduced from Release 19), it is highly feasible that the MAC CE command for SCG addition can be received before the MAC CE command for handover is received.

On receiving the MAC CE command for SCG addition in response to the L1 measurement report (Event LTM4), the SCG is added and the data path is reconfigured. Subsequently, the gNB may send the L1 handover command through MAC CE in response to the L1 measurement report for MCG (Event LTM3), and the UE 202 moves (handover) to the target cell, losing the SCG connection that was just added.

Hence, the existing method causes unnecessary measurements by the UE 202 and wastes network resources, as the SCG is momentarily added and removed due to the MCG change. The UE 202 may experience a temporary data stall or a drop-in data rate as PDCP and RLC may be re-established upon SCG addition, and the data split ratio is reset. This also leads to wasted power consumption due to unnecessary SCG measurements and can cause a drop-in data rate due to L2 data path reconfiguration, thereby negatively affecting the user experience.

FIG. 7A is an example sequence diagram illustrating the coexistence of LTM SCG addition and LTM MCG change events, according to the related art.

Referring to operation 7-1, the UE 202 (e.g., RRC 202A and L1 202B) is connected to the gNB1 210A of the cell A 210. In operation 7-2, the gNB1 210A configures the UE 202 with LTM measurement events for MCG cell change to target Cell-B (gNB3). In operation 7-3, the gNB1 210A configures an LTM measurement event for the SCG addition involving cell-A 210 (gNB2 210B). In operation 7-3A, the UE 202 performs LTM measurements for the handover event while also being configured for SCG addition. In operation 7-4, the UE 202 continues performing LTM measurements for the SCG addition even after sending the measurement report for the LTM handover event. In operation 7-4A, the UE 202 performs LTM measurements for the SCG addition and sends the measurement report even though the UE 202 has already sent measurements for LTM handover event.

In operation 7-5, the SCG addition condition is fulfilled, and the UE 202 sends the SCG measurement report. In operation 7-6, the SCG is added, but since the LTM handover is pending, the SCG is soon removed. Finally, in operation 7-7, the UE 202 hands over to target Cell-B (gNB3) and the SCG is removed. Hence, the FIG. 7A shows the simultaneous LTM events, which leads to redundant SCG measurements and momentary SCG addition before handover.

FIG. 7B is an example flow diagram 700 illustrating the coexistence of LTM SCG addition and LTM MCG change events, according to the related art.

Referring to FIG. 7B, in operation 702, the UE 202 is connected to the gNB 204, wherein the gNB configures the LTM events for handover and LTM events for SCG addition. In operation 704, the UE 202 performs measurements for LTM event for handover and SCG addition. In operation 706, the LTM event for handover is satisfied and the UE 202 sends measurement report to gNB for handover. The UE 202 is evaluating LTM event for SCG addition. In operation 708, the UE 202 decides whether the LTM SCG addition event condition is satisfied or not. On satisfying the condition, in operation 712, the UE 202 sends measurement report for SCG addition LTM event. On not satisfying the condition, in operation 710, the UE 202 keeps evaluating LTM event for SCG addition. Finally, in operation 714, the gNB triggers handover of UE 202 to target cell and UE 202 moves to new gNB. Therefore, the UE 202 unnecessarily performs measurements for the LTM SCG addition event, while waiting for the handover command from the network. The UE 202 is handed over to the target cell, causing all SCG events to become overhead, and the added SCG cells are lost.

FIG. 8 is an example time sequence diagram, wherein the UE 202 keeps measuring measurement of the LTM event for the SCG addition, according to the related art.

Referring to FIG. 8, the UE 202 continues to configure with the LTM for handover measurement, where the UE 202 sends measurement report for LTM handover event. The UE 202 continues performing LTM/CPA measurements for SCG addition. Thus, results in a short-lived SCG addition before the handover command is received from the network. Once the handover is executed, the SCG is removed, leading to unnecessary measurements, signaling overhead, and temporary data path changes.

With the introduction of conditional L1/L2 triggered mobility (C-LTM) in Release 19, as per the RAN2 agreement, the coexistence of LTM, C-LTM, and CHO event configurations is possible in the UE 202. The network may configure the UE 202 with conditional LTM events, along with their associated configurations and execution conditions, together with LTM events for handover.

Consider a scenario where the UE 202 is connected to the MCG cell with no SCG cell connected. The network can provide the UE 202 with conditional LTM SCG configuration along with execution conditions for SCG addition. The network can also configure LTM events for MCG change (handover) in the UE 202 at the same time as conditional LTM SCG events for SCG addition. The UE 202 can perform measurements for both events independently.

The LTM event for MCG cell change (handover) is fulfilled before the SCG conditional event is satisfied. In this case, the UE 202 sends an L1 measurement report to the gNB 204 and waits for the gNB to trigger the handover to the LTM candidate cell through the MAC CE. Since the 3GPP specification does not restrict LTM conditional event measurements for SCG addition after the UE 202 sends the LTM measurement report for MCG change, the UE 202 continues evaluating the LTM execution conditions for the conditional LTM SCG candidate cell.

When the SCG conditional LTM event execution conditions are satisfied, the UE 202 applies the configuration, and the SCG is added. Subsequently, the gNB 204 sends the L1 handover command through the MAC CE in response to the L1 measurement report sent by the UE 202, and the UE 202 hands over to the target cell, losing the SCG connection that was just added.

Hence, the existing method causes unnecessary measurements by the UE 202 and results in wasted network resources, as the SCG is added momentarily and removed immediately due to the MCG change. The UE 202 may experience a temporary data stall or drop-in data rate as PDCP and RLC may be re-established upon SCG addition, and the data split ratio is reset. This also leads to excess power consumption due to unnecessary SCG measurements and can cause a drop-in data rate due to L2 data path reconfiguration, ultimately affecting user experience.

FIG. 9A is an example flow diagram illustrating the co-existence of conditional LTM based SCG addition and LTM MCG changes, according to the related art.

Referring to FIG. 9A, in operation 9-1, the UE 202 (e.g., RRC 202A and L1 202B) is connected with the source cell (Cell-A, gNB1). In operation 9-2, the gNB1 210A, configures LTM events for MCG cell change (handover to target Cell-B, gNB3). In operation 9-3, the gNB1 210A configures conditional LTM configuration and execution condition for SCG addition of Cell-A (gNB2). In operation 9-4, the L1 measurement report to gNB1 210A for LTM event for MCG cell change is performed. In operation 9-4A, the UE 202 measures conditional LTM for SCG associated execution condition and applies target cell configuration once the execution condition is satisfied. In operation 9-4B, the UE 202 continues measuring conditional LTM execution condition even after sending measurement report for handover. In operation 9-5, the UE 202 adds SCG cell upon conditional LTM event fulfilment and data transmission is started on SCG leg. In operation 9-5A, conditional LTM condition is satisfied and the UE 202 applies SCG addition configuration.

In operation 9-6, the MAC CE for handover to target cell is performed. In operation 9-6A, the UE 202 adds SCG based on conditional LTM event fulfilment, but due to LTM handover, the SCG cell is lost shortly after. This causes unnecessary signaling and re-establishment of data paths. In operation 9-7A the UE 202 hands over to the target cell based on MAC CE. In operation 9-7, the UE 202 completes handover to target Cell-B (gNB3) and SCG cell is lost.

FIG. 9B is an example flow diagram 900 illustrating the coexistence of conditional-LTM based SCG addition and LTM MCG change while the UE 202 gets handed over to target cell and SCG events become overhead, according to the related art.

Referring to FIG. 9B, in operation 902, the UE 202 is connected to the gNB, wherein the gNB configures LTM events for handover and conditional-LTM configuration for SCG candidate cells and associated execution conditions. In operation 904, the UE 202 performs measurements for the LTM events for handover and evaluates C-LTM execution conditions for SCG addition. In operation 906, the LTM event for handover is satisfied and the UE 202 sends measurement report to gNB for handover. The UE 202 is evaluating C-LTM for SCG associated execution conditions. In operation 908, the UE 202 checks whether the C-LTM for SCG associated execution condition is satisfied or not. On satisfying the condition in operation 912, the UE 202 applies C-LTM for SCG configuration once associated execution condition is satisfied and SCG is added. The UE 202 re-establishes PDCP/RLC for SCG addition and splits data between MCG and SCG. On not satisfying the condition in operation 910, the UE 202 keeps evaluating C-LTM for SCG associated execution condition. Finally in operation 914, gNB triggers handover of the UE 202 to target cell and the UE 202 moves to new gNB and added SCG cell is lost UE's data path switches to MCG again.

Hence, the UE 202 un-necessarily evaluates CPA execution event and adds SCG cell upon evaluation completion, even though it sends LTM measurement event for MCG and waiting for handover command from network. The UE 202 gets handed over to target cell and all SCG events become overhead and added SCG cells are lost.

The above information is presented as background information only to assist with an understanding of the disclosure. No determination has been made, and no assertion is made, as to whether any of the above might be applicable as prior art with regard to the disclosure.

### Objects

Aspects of the disclosure are to address at least the above-mentioned problems and/or disadvantages and to provide at least the advantages described below. Accordingly, an aspect of the disclosure is to provide methods and systems for handling a handover of a User Equipment (UE) in a wireless communication network.

An aspect of the disclosure is to prevent the measurements for SCG event associated with CPA addition or LTM event or conditional LTM event of SCG candidate cell after the UE sends LTM based measurement report for MCG cell change and waiting for cell switch command and stops momentary SCG addition.

An aspect of the disclosure is to provide that the UE runs the back-off timer after the UE sends LTM based measurement report for MCG cell change while waiting for cell switch command and stops the measurements for SCG event associated with CPA addition or LTM event or conditional LTM event of SCG candidate until the back-off timer gets expired where back off timer can be UE configurable or value received from the network.

An aspect of the disclosure is to provide that the UE stops applying the CPA configuration or conditional LTM configuration or both configuration for SCG cell even after associated evaluation conditions gets satisfied either without timer or until the back off timer gets expired when the UE waits for cell switch command for MCG change after sending L1 measurement report of LTM events for MCG cell change.

An aspect of disclosure is to provide that the UE stops sending measurement report of SCG candidate cell associated with LTM event of SCG cell either without timer or until the back off timer gets expired when the UE waits for cell switch command for MCG change after sending L1 measurement report of LTM events for MCG cell change.

Additional aspects will be set forth in part in the description which follows and, in part, will be apparent from the description, or may be learned by practice of the presented embodiments.

### SUMMARY

In accordance with an aspect of the disclosure, a method for handling a handover of a user equipment (UE) in a wireless network is provided. The method includes receiving, by the UE, a layer trigger mobility (LTM) configuration message to perform a master cell group (MCG) cell change from a first network entity. Further, the method includes receiving, by the UE, a secondary cell group (SCG) addition message from the first network entity. The SCG addition message includes at least one of a primary secondary cell (PSCell) addition configuration and a conditional execution event (CPA) associated with the PSCell addition configuration, the PSCell addition configuration and an LTM execution condition associated with the PSCell addition configuration, or the PSCell addition configuration and a conditional LTM (C-LTM) execution condition associated with the PSCell addition configuration. Further, the method includes sending, by the UE, an MCG measurement report for handover and stopping a measurement event and execution of an associated SCG cell. Further, the method includes performing, by the UE, the handover of the UE to a second network entity based on handover information.

In accordance with an aspect of the disclosure, a method for handling a handover of a UE in a wireless network is provided. The method includes receiving, by a UE, a LTM configuration message and conditions for MCG change from a network entity. Further, the method includes receiving, by the UE, at least one of a conditional handover message including CPA configuration and execution condition, an LTM execution message including PSCell addition configuration and LTM execution condition, or an LTM execution message including PSCell addition configuration and conditional LTM execution condition. Further, the method includes measuring, by the UE, candidate cell of the MCG change configuration condition. Further, the method includes measuring and evaluating, by the UE, at least one of the CPA configuration condition, LTM event for PSCell addition configuration conditions, or conditional LTM event for PSCell addition configuration conditions. Further, the method includes sending, by the UE, a L1 measurement report for the LTM event to the network entity. Further, the method includes stopping, by the UE, measurement of CPA associated execution condition.

In accordance with an aspect of the disclosure, a method for handling a handover of a UE in a wireless network is provided. The method includes sending, by a first network entity, a LTM configuration message to perform a MCG cell change to the UE. Further, the method includes sending, by the first network entity, a SCG addition message to the UE. The SCG addition message includes at least one of a PSCell addition configuration and a CPA associated with the PSCell addition configuration, a configuration for PSCell addition and an LTM execution condition associated with the configuration, and a configuration for PSCell addition and a conditional LTM execution condition associated with the configuration. Further, the method includes receiving, by the first network entity, an MCG measurement report for handover from the UE based on the LTM configuration message. Further, the method includes sending, by the first network entity, a handover information to the UE based on the MCG measurement report.

In accordance with an aspect of the disclosure, a UE is provided. The UE includes at least one processor coupled with memory comprising one or more storage media, storing one or more computer programs. The one or more computer programs include computer-executable instructions that, when executed by the at least one processor individually or collectively, cause the UE to receive a LTM configuration message to perform a MCG cell change from a first network entity. Further, the one or more computer programs, when executed by the at least one processor individually or collectively, cause the UE to receive a SCG addition message from the first network entity. The SCG addition message includes at least one of a PSCell addition configuration and a CPA associated with the PSCell addition configuration, a configuration for PSCell addition and a LTM execution condition associated with the configuration, and a configuration for PSCell addition and a conditional LTM execution condition associated with the configuration. Further, the one or more computer programs, when executed by the at least one processor individually or collectively, cause the UE to send an MCG measurement report for handover and stop a measurement event and execution of the associated SCG cell. Further, the one or more computer programs, when executed by the at least one processor individually or collectively, cause the UE to perform the handover of the UE to a second network entity based on handover information.

In accordance with an aspect of the disclosure, a UE is provided. The UE includes memory and at least one processor coupled with the memory comprising one or more storage media, storing one or more computer programs. The one or more computer programs include computer-executable instructions that, when executed by the at least one processor individually or collectively, cause the UE to receive a LTM configuration message and conditions for MCG change from a network entity. Further, the one or more computer programs, when executed by the at least one processor individually or collectively, cause the UE to receive at least one of a conditional handover message including CPA configuration and execution condition, an LTM execution message including PSCell addition configuration and LTM execution condition, or an LTM execution message including PSCell addition configuration and conditional LTM execution condition. Further, the one or more computer programs, when executed by the at least one processor individually or collectively, cause the UE to measure candidate cell of the MCG change configuration condition. Further, the one or more computer programs, when executed by the at least one processor individually or collectively, cause the UE to evaluate at least one of the CPA configuration condition, LTM event for PSCell addition configuration conditions, or conditional LTM event for PSCell addition configuration conditions. Further, the one or more computer programs, when executed by the at least one processor individually or collectively, cause the UE to send a L1 measurement report for the LTM event to the network entity. Further, the one or more computer programs, when executed by the at least one processor individually or collectively, cause the UE to stop measurement of CPA associated execution condition

In accordance with an aspect of the disclosure, a first network entity is provided. The first network entity includes memory and at least one processor coupled with the memory comprising one or more storage media, storing one or more computer programs. The one or more computer programs include computer-executable instructions that, when executed by the at least one processor individually or collectively, cause the first network entity to send an LTM configuration message to perform an MCG cell change to the UE. Further, the one or more computer programs, when executed by the at least one processor individually or collectively, cause the first network entity to send a SCG addition message to the UE. The SCG addition message includes at least one of a PSCell addition configuration and a CPA associated with the PSCell addition configuration, a configuration for PSCell addition and a LTM execution condition associated with the configuration, a configuration for PSCell addition and a conditional LTM execution condition associated with the configuration. Further, the one or more computer programs, when executed by the at least one processor individually or collectively, cause the first network entity to receive an MCG measurement report for handover from the UE based on the LTM configuration message. Further, the one or more computer programs, when executed by the at least one processor individually or collectively, cause the first network entity to send a handover information to the UE based on the MCG measurement report.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is an example diagram illustrating the UE sending measurement report for LTM handover event, while LTM/CPA/C-LTM configuration is used for SCG addition, according to the related art;

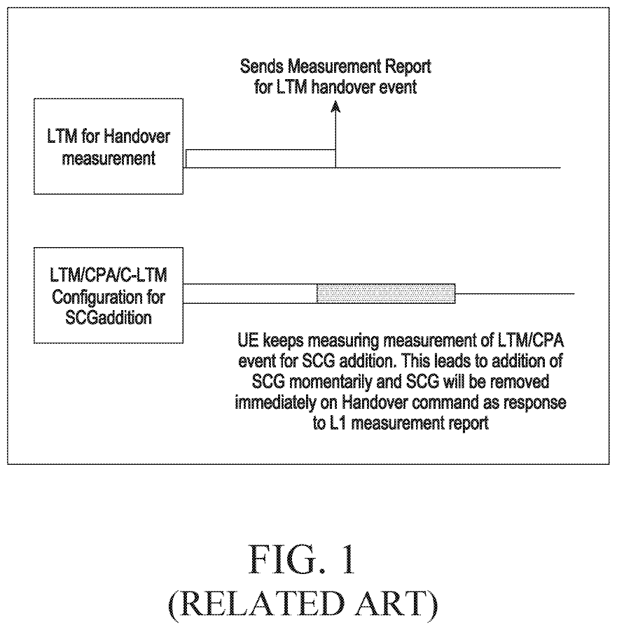

FIGS. 2A and 2B are example flow diagrams illustrating CHO and SCG addition through CPA, according to the related art;

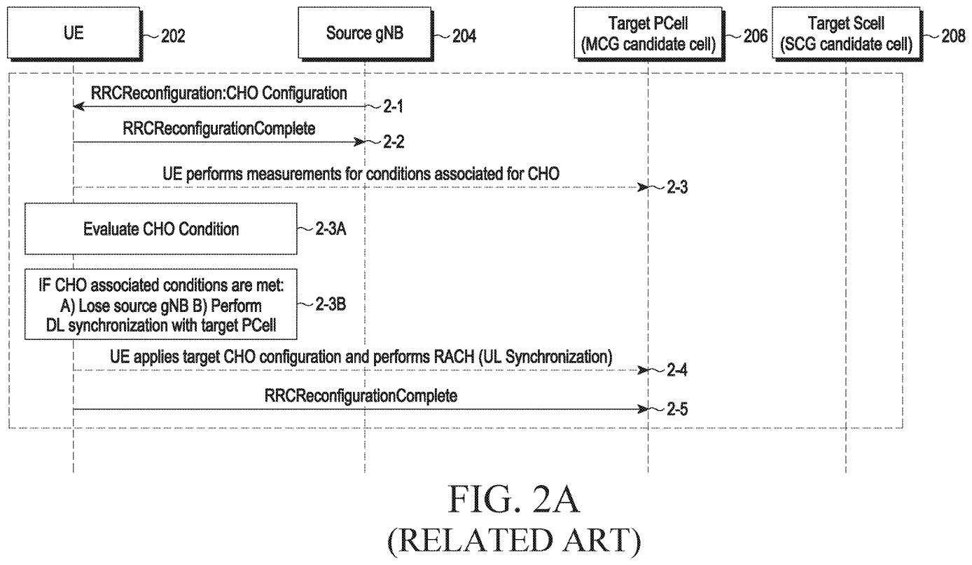

FIG. 3 is an example flow diagram illustrating various operations involved in LTM preparation, LTM cell switch execution, and LTM SCG addition execution, according to the related art;

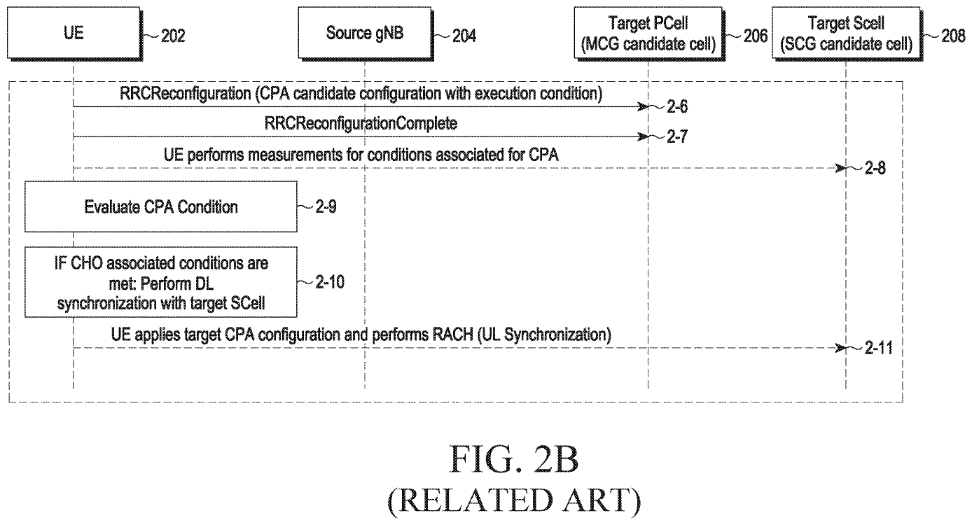

FIG. 4A is an example diagram illustrating the interaction of various layers for bearer reset upon SCG addition and handover, according to the related art;

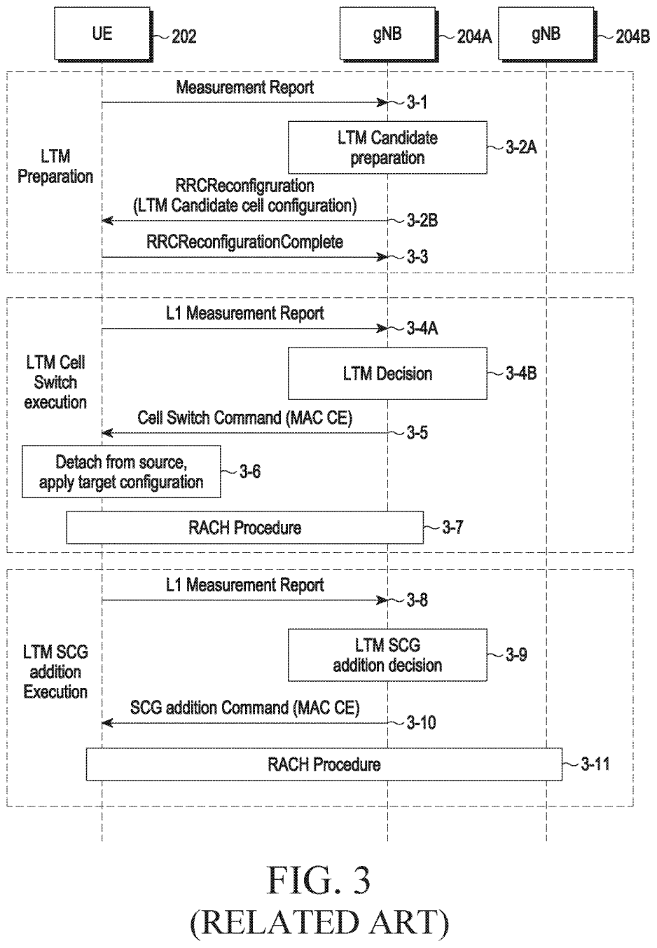

FIG. 4B is an example graph diagram illustrating the throughput spike followed by a sharp drop, causing a data path instability caused by momentary SCG addition, according to the related art;

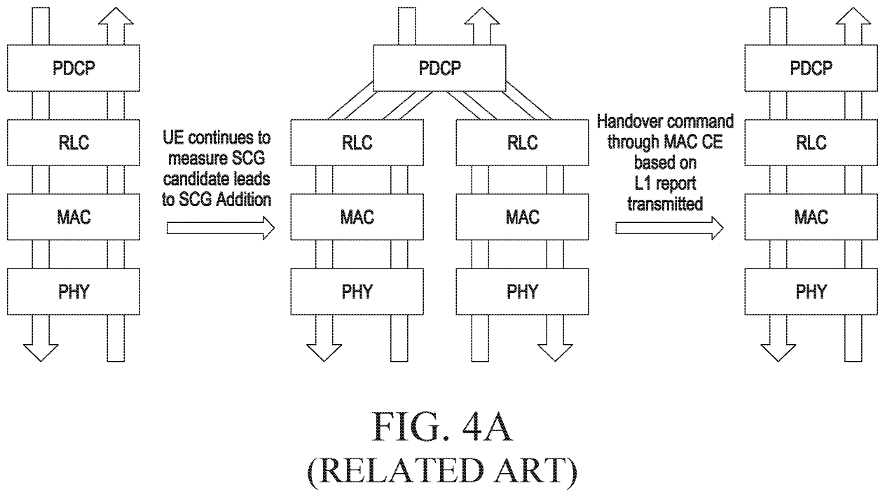

FIG. 5A is an example sequence diagram wherein the UE is configured with both LTM for MCG change and CPA for SCG addition event, leading to inefficient SCG handling during handover, according to the related art;

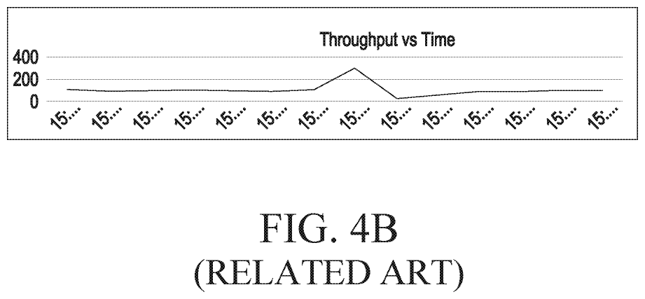

FIG. 5B is an example flow diagram illustrating the co-existence of conditional SCG addition and LTM MCG change in the UE, according to the related art;

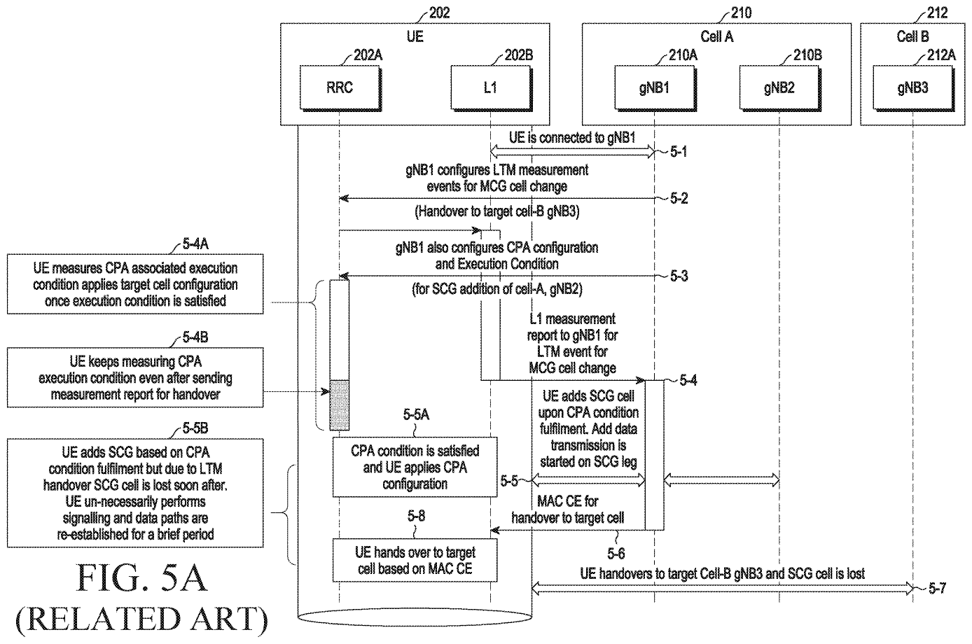

FIG. 6 is an example time sequence diagram illustrating the UE configured with the LTM for MCG handover, according to the related art;

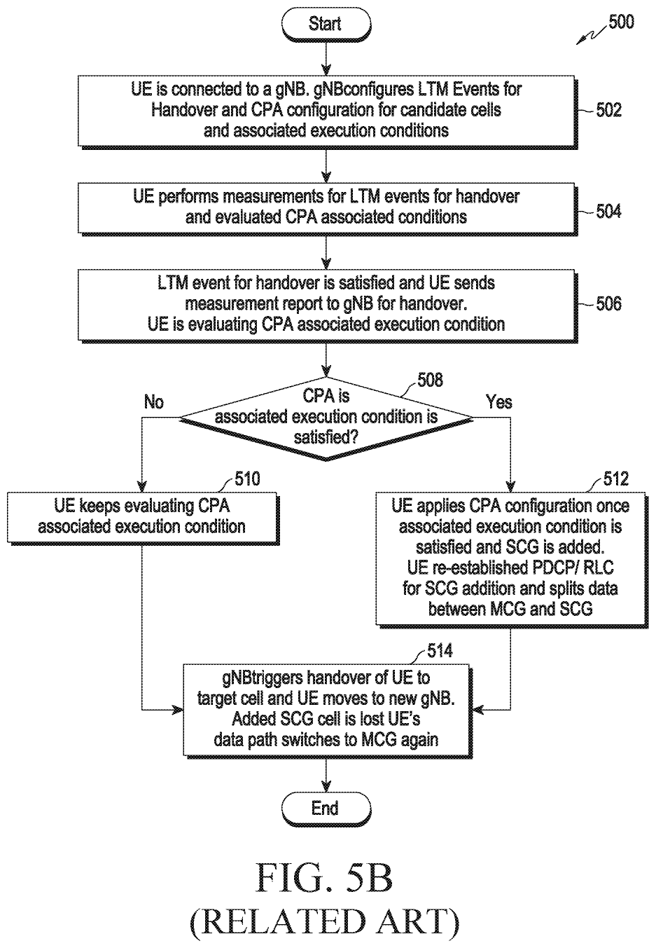

FIG. 7A is an example sequence diagram wherein the UE is configured with LTM measurement events (MCG handover) and another for SCG addition, according to the related art;

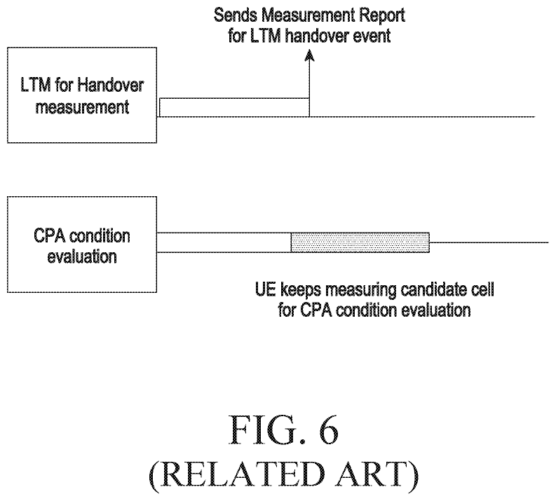

FIG. 7B is an example flow diagram wherein the UE performs both the LTM SCG addition and the LTM MCG change event, according to the related art;

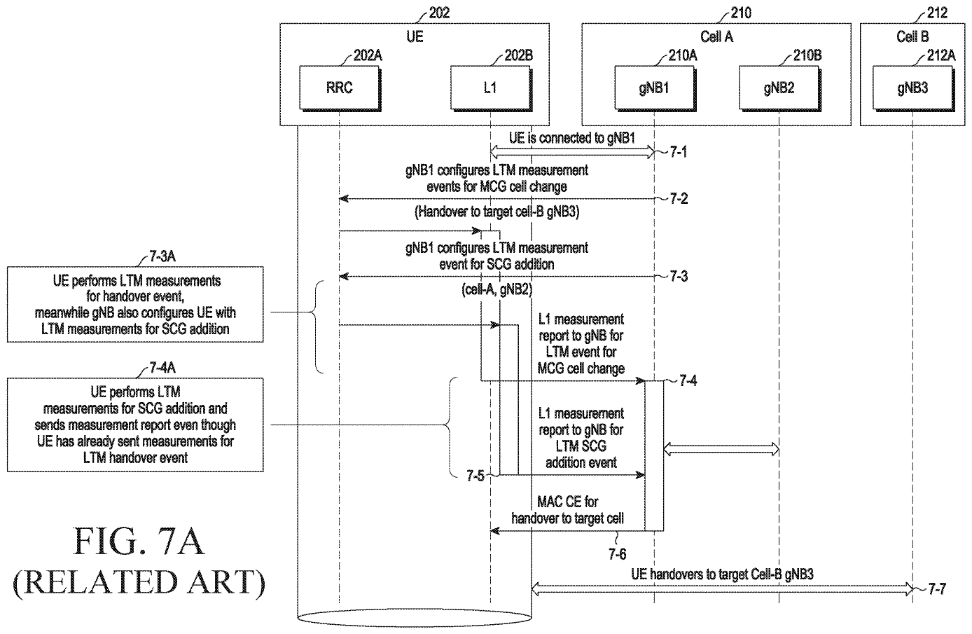

FIG. 8 is an example time sequence diagram, wherein the UE keeps measuring measurement of the LTM event for the SCG addition, according to the related art;

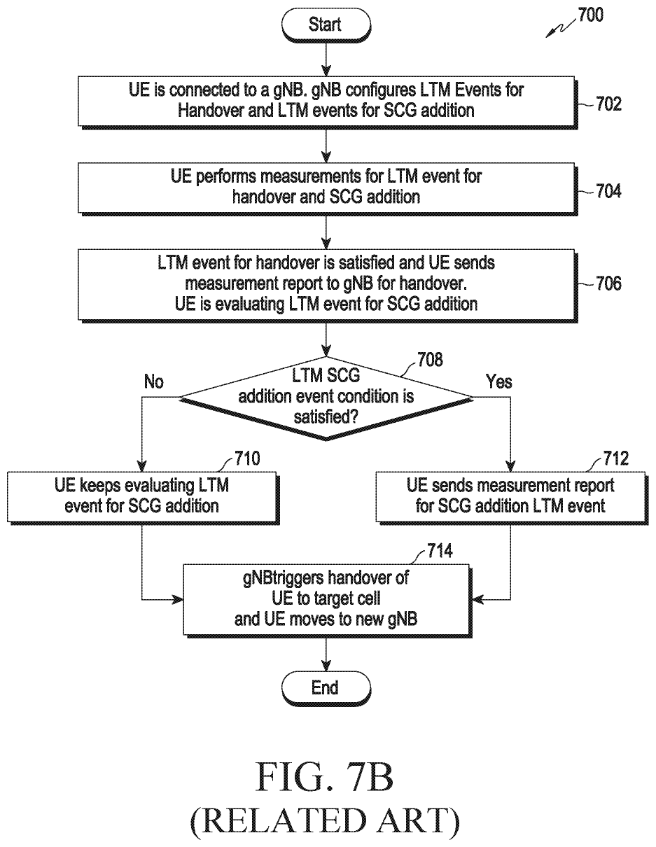

FIG. 9A is an example flow diagram illustrating the co-existence of conditional LTM based SCG addition and LTM MCG changes, according to the related art;

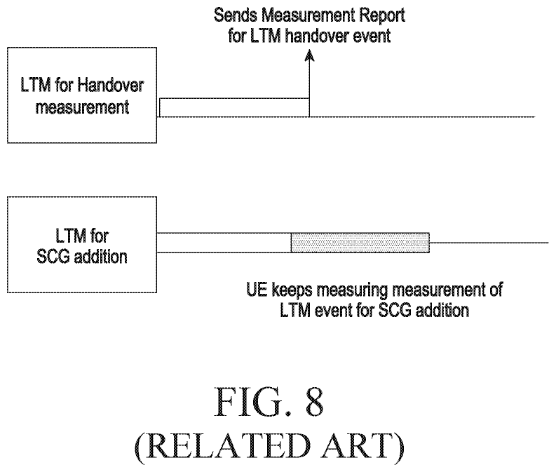

FIG. 9B is an example flow diagram illustrating the coexistence of conditional-LTM based SCG addition and LTM MCG change while UE gets handed over to target cell and SCG events become overhead, according to the related art;

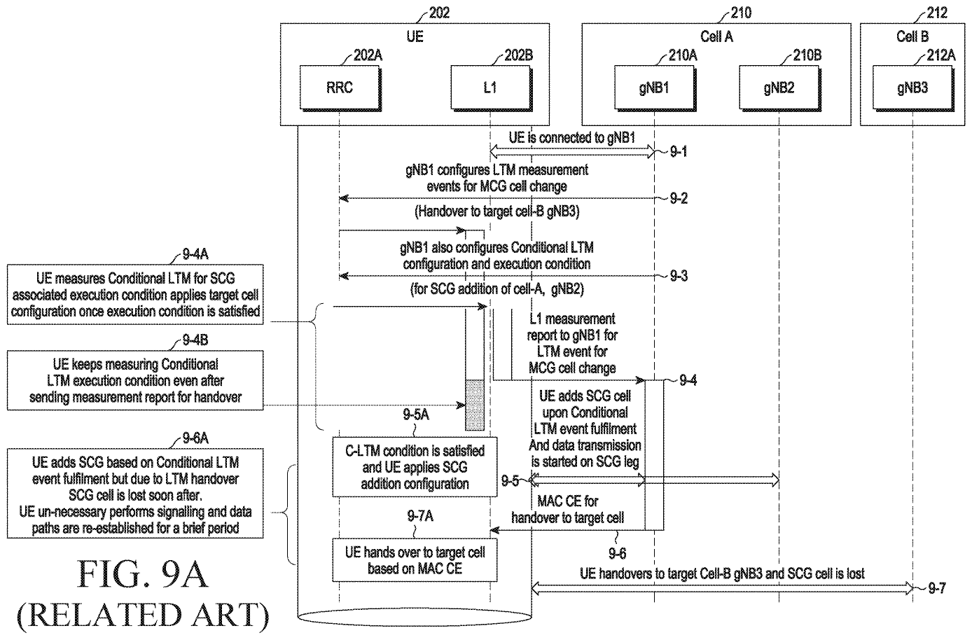

FIG. 10 includes example diagrams illustrating a bearer maintenance by preventing SCG addition and after handover, while the UE stops measuring to prevent momentary SCG addition, according to various embodiments of the disclosure;

FIGS. 11 and 12 are example diagrams illustrating the UE stops measuring the CPA associated conditions and LTM events for SCG addition while performing handover, according to various embodiments of the disclosure;

FIG. 13 is an example flow diagram illustrating the coexistence of conditional SCG addition and LTM MCG change without timer, according to an embodiment of the disclosure;

FIG. 14 is an example flow diagram illustrating the coexistence of conditional SCG addition and LTM MCG change with timer, according to an embodiment of the disclosure;

FIG. 15 is an example flow diagram illustrating the coexistence of conditional SCG addition and LTM MCG change without timer, according to an embodiment of the disclosure;

FIG. 16 is an example flow diagram illustrating the coexistence of conditional SCG addition and LTM MCG change with timer, according to an embodiment of the disclosure;

FIG. 17 is an example flow diagram illustrating the coexistence of conditional SCG addition and LTM MCG change without timer, according to an embodiment of the disclosure;

FIG. 18 is an example flow diagram illustrating the coexistence of conditional SCG addition and LTM MCG change with timer, according to an embodiment of the disclosure;

FIG. 19 is an example diagram illustrating the UE stops measuring or sending report for LTM SCG event while waiting for handover command, according to an embodiment of the disclosure;

FIG. 20 is an example diagram illustrating the UE stops measuring or sending report for LTM SCG event while waiting for handover command until back-off timer expiry, according to an embodiment of the disclosure;

FIG. 21 is an example flow diagram illustrating the coexistence of C-LTM based SCG addition and LTM MCG change without timer, according to an embodiment of the disclosure;

FIG. 22 is an example flow diagram illustrating the coexistence of conditional LTM based SCG addition and LTM MCG change with timer based, according to an embodiment of the disclosure;

FIG. 23 is an example diagram illustrating the UE stops measuring or applying C-LTM configuration for SCG addition while waiting for Handover command, according to an embodiment of the disclosure;

FIG. 24 is an example diagram illustrating the UE stops measurement/applying C-LTM configuration for SCG addition while waiting for Handover command until back-off timer expiry, according to an embodiment of the disclosure;

FIG. 25 is an example diagram illustrating hardware components of the UE for handling the handover of the UE in the wireless communication network, according to an embodiment of the disclosure;

FIG. 26 is an example diagram illustrating hardware components of the first network entity, for handling the handover of the UE in the wireless communication network, according to an embodiment of the disclosure;

FIG. 27 is an example flow diagram depicting a method for handling a handover of the UE in a wireless network, by the UE, according to an embodiment of the disclosure;

FIG. 28 is an example flow diagram depicting a method handling a handover of the UE in the wireless network, by the UE, according to an embodiment of the disclosure;

FIG. 29 is an example flow diagram depicting a method for handling a handover of the UE in the wireless network, by the first network entity, according to an embodiment of the disclosure; and

FIG. 30 is an example graph diagram illustrating the user experience with data throughput against time, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of operations for an understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/operations is for the purposes of this description and should not be construed as sequential ordering/placement/occurrence unless specified otherwise.

Hereinafter, embodiments of the disclosure will be described in detail with reference to the accompanying drawings. In describing the embodiments, descriptions related to technical contents well-known in the art and not associated directly with the disclosure will be omitted. Such an omission of unnecessary descriptions is intended to prevent obscuring of the main method of the disclosure and more clearly transfer the main method.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded individually or collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operations to be performed on the computer or other programmable data processing apparatus to produce a computer executed process such that the instructions that perform on the computer or other programmable data processing apparatus provide operations for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “~unit/module” may refer to a software element or a hardware element, such as a field programmable gate array (FPGA) or an application specific integrated circuit (ASIC), which performs a predetermined function. However, the term including the word “~unit/module” does not always have a meaning limited to software or hardware. The “~unit/module” may be constructed either to be stored in an addressable storage medium or to execute one or more processors. Therefore, the “~unit/module” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “~unit/module” may be either combined into a smaller number of components and a “~unit/module,” or divided into additional components and a “~unit/module.” Moreover, the components and “~units/module” may be implemented to reproduce one or more central processing units (CPUs) within a device or a security multimedia card. Further, in the embodiments, the “^{~}unit/module” may include one or more processors.

The entirety of the one or more computer programs may be stored in a single memory device, or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, microprocessors, microcontrollers, digital signal processors, FPGA, ASIC, a microprocessor unit (MPU), a system on chip (SoC), an IC, or the like. The one processor or the combination of processors executes instructions that can be stored in memory, such as the operating system, in order to control the overall operation of the device. Also, the one processor or the combination of processors is also capable of executing other processes and programs resident in the memory, such as processes for the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure. Additionally, or alternatively, such software may be a computer program (product) comprising instructions which, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the disclosure may provide a program comprising code for implementing apparatus or a method as claimed in any one of the claims of this specification and a non-transitory machine-readable storage storing such a program.

Hereinafter, the determination of priority between A and B in the disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the disclosure may be understood as “A and/or B,” which may include A, or B, or both A and B.

In addition, “at least one of A, B, and C” as described in the disclosure may be understood to include A, or B, or C, or any combination of A, B, and C.

In addition, “at least one of A, B, or C” as described in the disclosure may be understood to include A, or B, or C, or any combination of A, B, and C.

Furthermore, “A/B” as described in the disclosure may be understood as “A and/or B,” which may include A, or B, or both A and B.

Furthermore, “A, B” as described in the disclosure may be understood as “A and/or B,” which may include A, or B, or both A and B.

Furthermore, “A and B” as described in the disclosure may be understood as “A and/or B,” which may include A, or B, or both A and B.

Furthermore, “if condition A and condition B are satisfied,” as described in the disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, elements or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first~”, “second~”, etc., as described in the disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ~” and “second~” are described in the disclosure, it may be understood that element(s) referred to by “first~” and “second~” may be the same or different. For example, in case of element(s) being information, first information and second information may both be the same information, and, in some cases, are separate and different information.

In addition, the terms “if~” and “in case that~” as used in the disclosure or claims may be interpreted to include the meanings of “when (or upon) ~,” “in response to~,” “based on~,” or “according to~,” and may be used interchangeably with these expressions. In addition, expressions other than those exemplified herein may also be used, as long as they have substantially the same meaning and do not impair the technical features of the disclosure. If an operation (e.g., transmit a signal) is performed according to the disclosure of the application in connection with one of the above terms (such as “in case that~” or the like), it may be interpreted to include the meanings (disclosure) of a prior determination that a feature has a specific state “~” (e.g., a bit length is above X), and perform the operation in response to said determination.

In addition, the term “not perform” as used in the disclosure or claims may, in context, be understood to mean that the corresponding operation is omitted or skipped. Such a term may be replaced with other terms having the same or substantially equivalent meaning.

In addition, “transmitting a message including A and B” as described in the disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the disclosure described below, terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

The drawings or flowcharts described below illustrate example methods that may be implemented according to the principles of the disclosure, and various modifications may be made to the methods illustrated in the flowcharts of the disclosure. For example, although illustrated as a series of operations, various operations in each drawing or flowchart may overlap, occur in parallel, occur in a different order, or be repeated. In other examples, any step may be omitted or replaced with another operation.

The process of the flowchart may be performed by a device. One or more of the operations of the flowchart can be implemented by one or more processors/computer programs executing instructions to perform the noted functions.

The methods and apparatuses proposed in the embodiments of the disclosure may be disclosed in connection with drawings disclosing flowcharts to illustrate example methods that may be implemented according to the principles of the disclosure. Such flowcharts may contain different branches and/or sub-branches. It is understood that the principles of the disclosure do not only contain the combination of all branches/sub-branches disclosed in the embodiment, but the disclosure also contains at least one isolated branch/isolated sub-branch, in particular to a single branch/single sub-branch.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and an embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3rd generation partnership project (3GPP) technical specifications (TS) or similar technical specifications, e.g., from ETSI, where appropriate.

Hereinafter, a base station (BS) and the network entity is an entity that allocates resources to terminals, and may be at least one of a gNode B, an eNode B, a Node B, a wireless access unit, a BS controller, or a node on a network.

Furthermore, the base station of the disclosure may include a split architecture comprising a central unit (CU) and a distributed unit (DU). In this structure, the CU is configured to process the higher layers of the control and user planes, while the DU is configured to process lower-layer radio resource functions. The embodiments of the disclosure may be equally applicable to 5^{th} generation (5G) base station architectures in which such CU and DU functional splits are implemented.

A terminal may include a UE, a mobile station (MS), a cellular phone, a smartphone, a computer, a tablet, a wearable device, an internet of things (IoT) device, or any other device/system capable of performing communication functions.

In the disclosure, a downlink (DL) refers to a radio link through which a BS transmits a signal to a terminal, and an uplink (UL) refers to a radio link through which a terminal transmits a signal to a BS.

Furthermore, hereinafter, 5^{th} generation (5G) mobile communication technologies (e.g., 5G new radio (NR)), 6^{th} generation (6G) mobile communication technologies may be described by way of example, but the embodiments of the disclosure may also be applied to other communication systems having similar technical backgrounds or channel types. For example, newly evolved mobile communication systems developed after 5G and 6G may be included. Furthermore, based on determinations by those skilled in the art, the embodiments of the disclosure may also be applied to other communication systems (e.g., Wi-Fi systems) through some modifications without significantly departing from the scope of the disclosure.

Hereinafter, in the context of the disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as Layer 3 (L3) signaling.

In addition, layer 1 (L1) signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

For example, the physical layer signaling (e.g., L1 signaling) may include DCI. In addition, the higher layer signaling may include a MAC control message, a RRC signaling message, a NAS signaling message, or an application layer message. The RRC signaling message may be referred to as L3 signaling. It should be noted, however, that the higher layer signaling is not limited to the aforementioned examples.

Hereinafter, the expression that information is configured by the BS, as used in the disclosure or claims, may, in context, be understood to mean that the terminal receives the corresponding information from the BS via a physical layer signaling or a higher layer signaling. Such an expression may be replaced with other terms having the same or substantially equivalent meaning.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

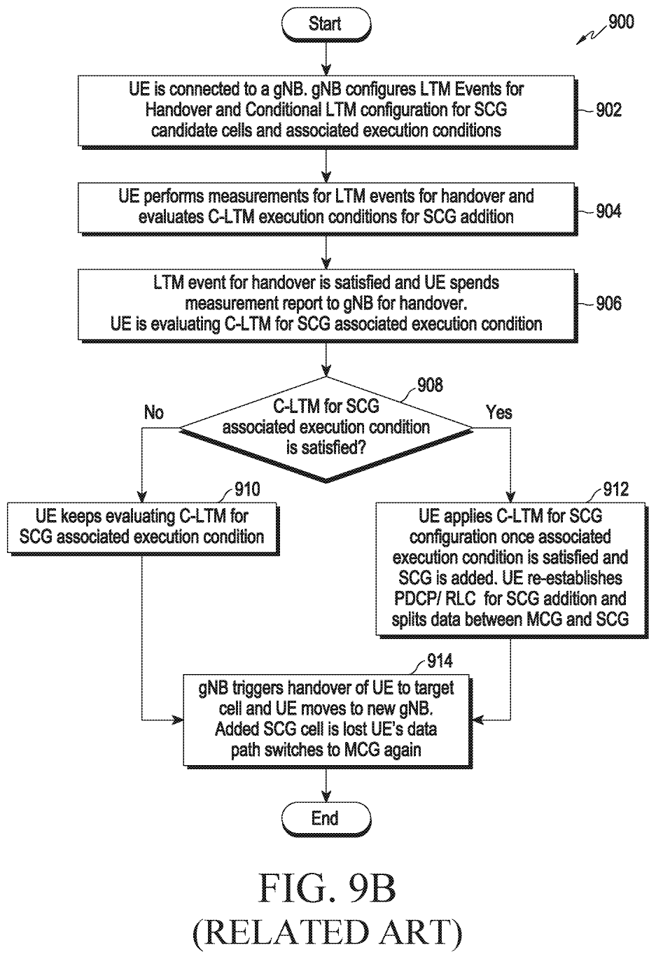

Referring now to the drawings, and more particularly to FIGS. 10 through 30, where similar reference characters denote corresponding features consistently throughout the figures, there are shown embodiments.

FIG. 10 include example diagrams illustrating a bearer reset upon SCG addition and handover, while the UE 202 stops measuring to prevent momentary SCG addition according to various embodiments of the disclosure. The UE 202 may be, for example, but not limited to a laptop, a desktop computer, a notebook, a device-to-device (D2D) device, a vehicle to everything (V2X) device, a smartphone, a foldable phone, a smart TV, a tablet, an immersive device, an IoT device, an extended reality (XR) device, a virtual reality (VR) device, an augmented reality (AR) device, a mixed reality (MR) device, a head-mounted display (HMD) device, AR glasses, a visual see-through (VST) device or the like.

Referring to (a) of FIG. 10, the UE 202 is connected with the MCG, and no SCG is added. Data activity is carried out on the MCG leg. The UE 202 performs LTM measurement for MCG change and LTM/CPA measurement for SCG addition, and sends the L1 report for MCG change.

Referring to (b) of FIG. 10, the UE 202 stops measurement to the SCG candidate cell after the transmission of L1 report for the MCG. As illustrated in (b) of FIG. 10, the handover command through MAC CE based on L1 report is transmitted. Therefore, based on the proposed method, the UE 202 stops measuring SCG candidate cells after transmitting the L1 report for MCG. Hence, the proposed method may be used to prevent the SCG addition, and the UE data path continues to be maintained on the MCG leg. The UE 202 avoids momentary SCG addition with no data fluctuation.

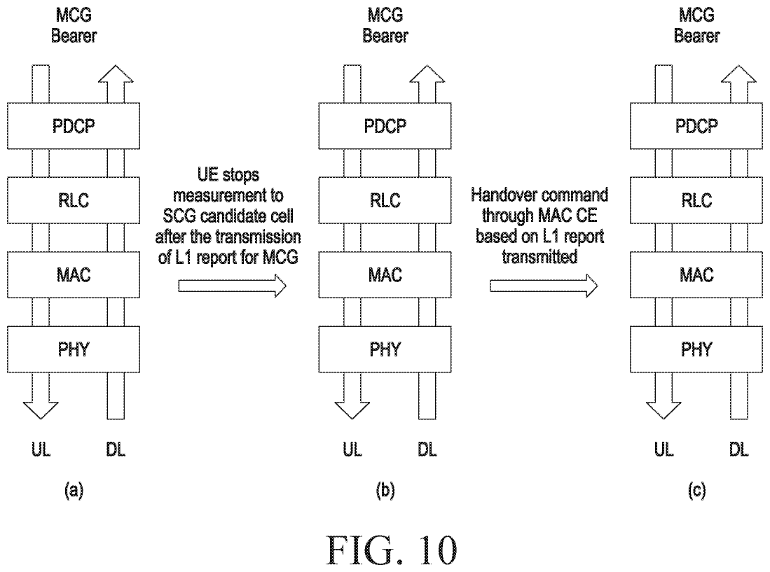

Referring to (c) of FIG. 10, the handover gets trigged as a result of L1 report transmitted for MCG change. Bearer remains intact as SCG is not added before. Therefore, the proposed method avoids unnecessary measurement and prevents momentary SCG addition leads to data stability and enhance user experience. The detailed operations of handling the handover of the UE 202 is explained in FIGS. 11 to 30.

FIGS. 11 and 12 are example diagrams illustrating the UE 202 stops measuring the CPA associated conditions and LTM events for SCG addition while performing handover according to various embodiments of the disclosure.

Referring to FIG. 11, the UE 202 sends the measurement report for LTM handover event while the UE 202 performs LTM for handover measurement. The UE 202 stops measuring CPA associated condition for SCG addition as soon as the UE 202 sends measurement reports for handover. Hence, the UE 202 saves power and does not perform un-necessary signaling.

Referring to FIG. 12, the UE 202 performs measurement for LTM MCG event and send the measurement report for LTM handover event The UE 202 stops measuring LTM event for SCG addition as soon as the UE 202 sends measurement report for handover. Hence, the UE 202 saves power and does not perform unnecessary signaling.

For an instance, consider a scenario in which the UE 202 is connected with MCG cell and no SCG cell is connected. The network may provide the UE 202 with SCG configuration along with execution condition for SCG addition and LTM events (e.g. Event LTM3/LTM5) for MCG change (handover) at same time. The UE 202 performs measurement of both the events independently. When any of the LTM events for MCG cell change (handover) gets fulfilled before SCG conditional event, the UE 202 sends L1 measurement report to the gNB 204 and waits for gNB to trigger handover to LTM candidate cell through MAC CE.

Based on the proposed method, the UE 202 stops measuring CPA associated execution conditions for SCG addition as the configuration and associated conditions will not be valid once the UE 202 moves to target cell based on gNB triggered handover to LTM candidate cell.

Hence, the proposed method is based on the analysis that even if the CPA associated conditions are satisfied and the UE 202 applies the target SCG cell configuration, the added SCG cell will be lost as soon as gNB triggers handover to LTM candidate cell through MAC CE.

In an embodiment, the UE 202 keeps measuring the CPA associated execution condition but the UE 202 does not apply the CPA configuration for SCG addition as it is waiting for the gNB 204 to trigger handover to neighbor cell. For enhancement, There is an embodiment that, the UE 202 will start a back-off timer after the UE 202 sends L1 measurement report for MCG candidate cell for handover.

The UE 202 stops the action associated with SCG candidate cell either performing measurements or apply the CPA configuration for SCG addition until the back off timer gets expired. The back off timer may be configurable value present in the UE 202 or it may be value sent by the network for this collision to avoid SCG addition and deletion within short time.

The proposed method makes the UE 202 to avoid unnecessary measurements of SCG cell and leads to power optimization. The UE 202 will avoid the momentary action of addition and deletion of SCG in short span of time which gains the UE 202 to avoid experience data stall or any drop-in data rate as PDCP will not be re-established upon SCG addition and data split ratio is also not reset.

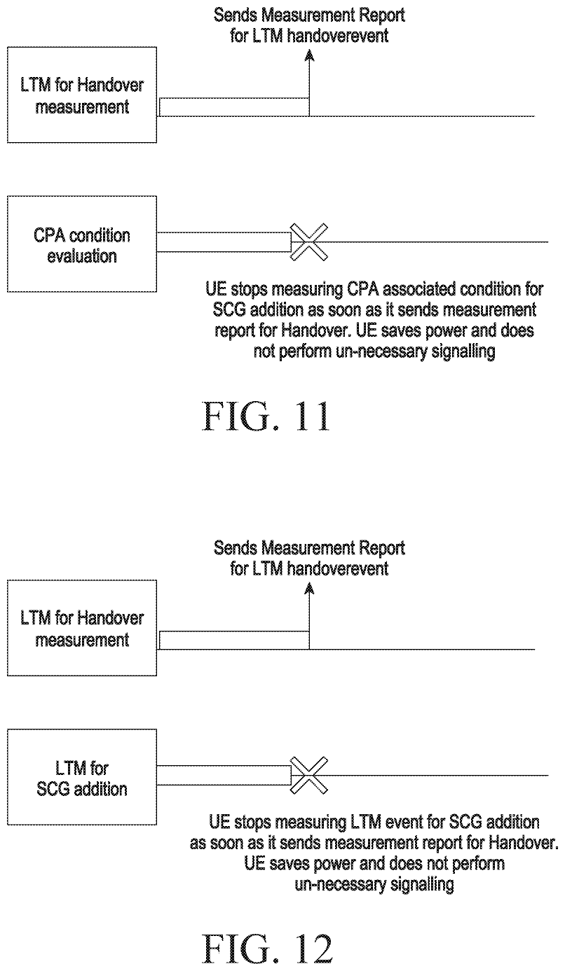

FIG. 13 is an example flow diagram illustrating the coexistence of conditional SCG addition and LTM MCG change without timer according to an embodiment of the disclosure.

Referring to FIG. 13, in operation 13-1, the UE 202 (e.g., RRC 202A and L1 202B) is connected with the source cell (gNB1 210A). In operation 13-2, the gNB1 210A configures LTM measurement events for MCG cell change (handover to target Cell-B, gNB3). In operation 13-3, the gNB1 210A also configures CPA configuration and execution condition for SCG addition (Cell-A, gNB2). In operation 13-3A, the UE 202 measures CPA-associated execution condition. In operation 13-4, the UE 202 sends the L1 measurement report to the gNB for LTM event for SCG cell change. In operation 13-4A (Alt1) the UE 202 stops measuring CPA-associated execution conditions as soon as the L1 measurement report for cell change is sent to gNB. In operation 13-4B (Alt2), the UE 202 continues evaluating CPA-associated execution conditions, but does not apply CPA configuration even if evaluation is successful. In operation 13-5, the UE 202 sends the L1 measurement report to gNB for the LTM event. In operation 13-6 (Alt1), the UE 202 stops measurement of CPA-associated execution conditions. In operation 13-7 (Alt2), the UE 202 continues CPA evaluation but does not apply CPA configuration. In operation 13-8, by skipping SCG addition, the UE 202 avoids unnecessary signaling and prevents data split threshold resets, since the UE 202 will soon be handed over to the neighbor cell. In operation 13-9, the UE 202 hands over to target Cell-B (gNB3 212A), and no SCG cell is lost. Therefore, in operation 13-10, unnecessary signaling for the SCG addition and data split threshold reset is avoided by the UE 202 by not adding SCG cell as the UE 202 soon gets handed over to neighbor cell.

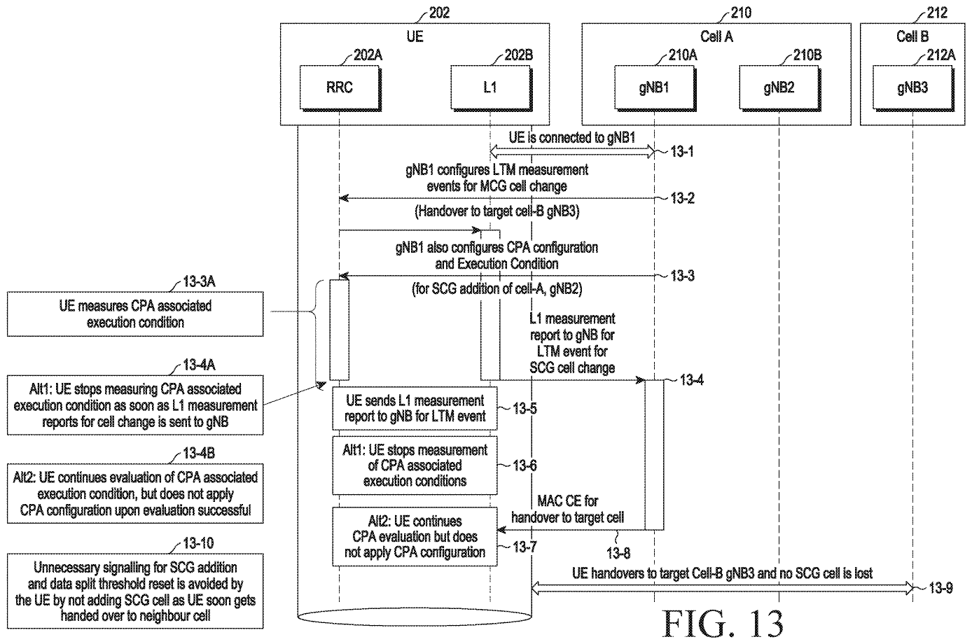

FIG. 14 is an example flow diagram illustrating the coexistence of conditional SCG addition and LTM MCG change with timer according to an embodiment of the disclosure.

Referring to FIG. 14, in operation 14-1, the UE 202 (e.g., RRC 202A and L1 202B) is connected with the source cell (gNB1 210A). In operation 14-2, the gNB1 210A, configures LTM measurement events for MCG cell change (handover to target Cell-B, gNB3 212A). In operation 14-3, the gNB1 210A also configures CPA configuration and execution condition for SCG addition (Cell-A, gNB2). In operation 14-4, the UE 202 sends the L1 measurement report to the gNB for LTM event to perform SCG cell change. In operation 14-4A, the UE 202 measures CPA-associated execution condition.

In operation 14-4B (Alt1), the UE 202 stops measuring CPA-associated execution conditions as soon as the L1 measurement report for cell change is sent to gNB. The UE 202 starts a timer to wait for the handover command from the network. If the handover command is not received before timer expiry, the UE 202 restarts measurement. In operation 14-4C (Alt2), the UE 202 continues evaluating CPA-associated execution conditions but does not apply CPA configuration even if the evaluation is successful. The UE 202 starts a timer to wait for the handover command from the network. If the handover command is not received before timer expiry and the condition is still satisfied, the UE 202 applies CPA configuration. In operation 14-5, the UE 202 sends L1 measurement report to gNB for the LTM event and starts the timer for handover command. In operation 14-6 (Alt1), the UE 202 stops measurement of CPA-associated execution conditions until timer expiry. In operation 14-7 (in an embodiment), the UE 202 continues CPA evaluation but does not apply CPA configuration until timer expiry. In operation 14-8, the MAC CE for handover to target cell is performed by the UE 202. In operation 14-9, the UE 202 hands over to target Cell-B (gNB3 212A), and no SCG cell is lost. Therefore, in operation 14-10, by not adding the SCG cell, unnecessary signaling for SCG addition and data split threshold reset is avoided, since the UE 202 soon gets handed over to the neighbor cell.

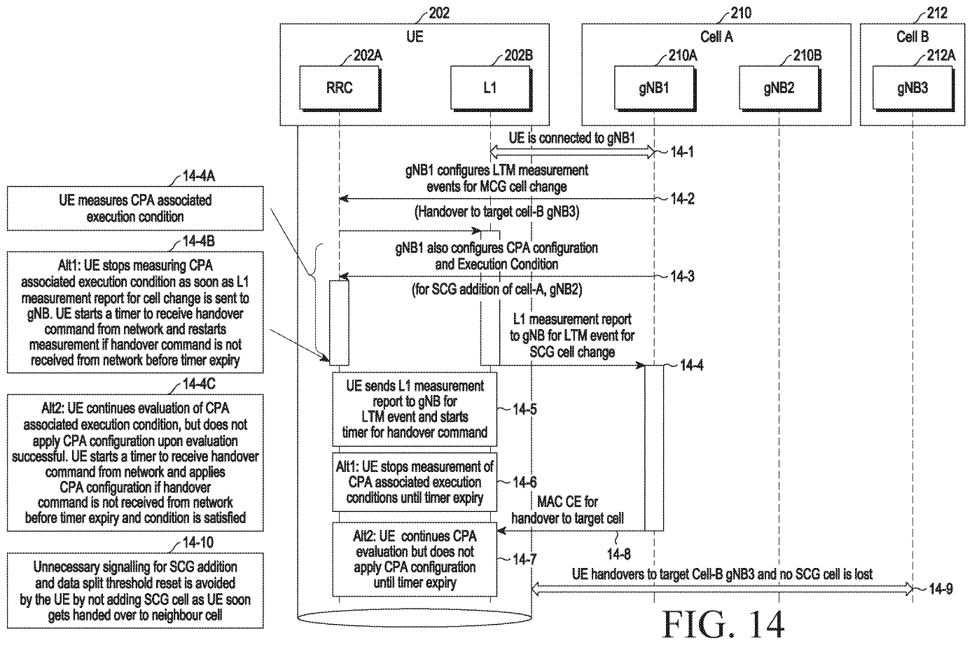

FIG. 15 is an example flow diagram 1500 illustrating the coexistence of conditional SCG addition and LTM MCG change without timer according to an embodiment of the disclosure.

In operation 1502, the UE 202 is connected to a gNB, wherein the gNB configures LTM events for handover. The gNB also configures CPA configuration and associated execution condition for SCG addition. In operation 1504, the UE 202 performs measurements for LTM events for handover and CPA associated execution conditions. In operation 1506, the LTM event for handover is satisfied and the UE 202 is performing measurements CPA associated execution confidants. In operation 1508, the UE 202 checks whether the CPA associated execution condition is satisfied or not. In operation 1510, on satisfying the condition, the UE 202 does not apply CPA configuration. In operation 1512, on not satisfying the condition in operation 1508, Alt1, wherein the UE 202 stops performing measurements for CPA associated execution condition and delete CPA/CHO/CPAC config and associated execution conditions. Alt2: Keep evaluation CPA associated execution condition but do not apply CPA configuration if evaluation is successful. Therefore, as illustrated in FIG. 15, the UE 202 stops measuring or applying CPA configuration for SCG while waiting for handover command

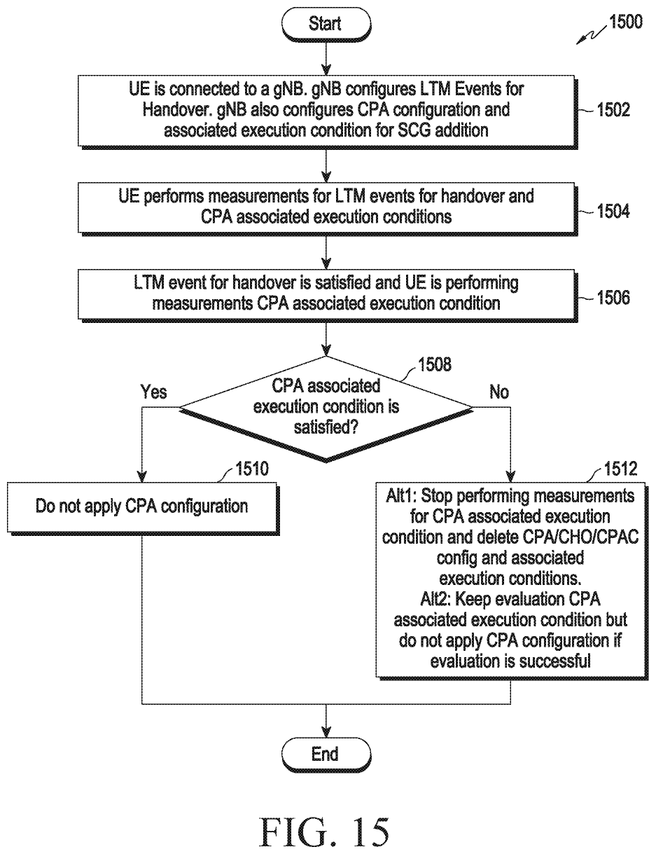

FIG. 16 is an example flow diagram 1600 illustrating the coexistence of conditional SCG addition and LTM MCG change with timer according to an embodiment of the disclosure.

Referring to FIG. 16, in operation 1602, the UE 202 is connected to the gNB, wherein the gNB configures LTM events for handover. The gNB also configures CPA configuration and associated execution condition for SCG addition. In operation 1604, the UE 202 performs measurements for LTM event for handover and CPA associated execution conditions. In operation 1606, the LTM event for handover is satisfied and the UE 202 is performing measurements CPA associated execution condition. In operation 1608, the UE 202 starts the timer for receiving LTM handover command in MAC CE. In operation 1610, the UE 202 checks whether the CPA associated execution condition is satisfied or not. In operation 1612, on satisfying the condition, the UE 202 do not apply CPA configuration until the expiry of timer. In operation 1614, on not satisfying the condition, in alt1, the UE 202 stops performing measurements for CPA associated execution condition. In alt2, the UE 202 keeps evaluating CPA associated execution condition but do not apply CPA configuration if evaluation is successful. In operation 1616, the MAC CE is received by the UE 202. In operation 1618, the UE 202 may discard the CPA configuration and associated execution condition. In operation 1620, on timer expired, in alt1, the UE 202 continue measurement for CPA associated execution condition and apply configuration once evaluation is successful. In alt2, if the CPA execution condition was successful earlier, the CPA configuration is applied. Therefore, as illustrated in FIG. 16, the UE 202 stops measuring or applying CPA configuration for SCG while waiting for handover command until back-off timer expiry.

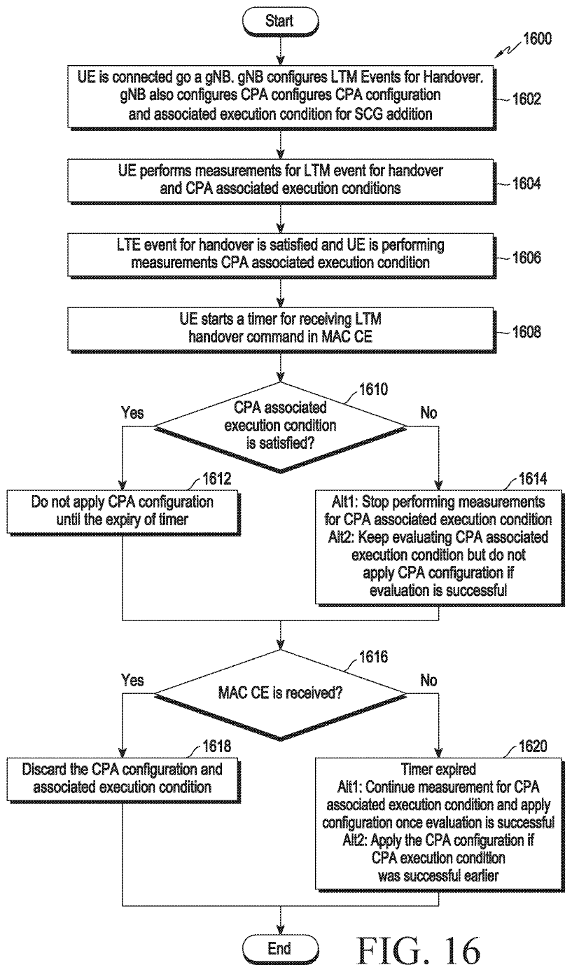

FIG. 17 is an example flow diagram illustrating the coexistence of conditional SCG addition and LTM MCG change without timer according to an embodiment of the disclosure.

Referring to FIG. 17, in operation 17-1, the UE 202 (e.g., RRC 202A and L1 202B) is connected with the serving gNB1 210A. In operation 17-2, the gNB1 210A configures LTM measurement events for MCG cell change (handover to target Cell-B, gNB3). In operation 17-3, the gNB1 210A also configures LTM measurement event for SCG addition (Cell-B, gNB3 212A). In operation 17-4, the UE 202 sends L1 measurement report to gNB for LTM event for handover. In operation 17-4A, the UE 202 performs LTM measurements for the MCG handover event. Meanwhile, the gNB also configures the UE 202 with LTM measurements for SCG addition. In operation 17-4B, the UE 202 starts measuring the LTM event for SCG addition. In operation 17-5 (Alt1), the UE 202 stops measuring LTM events for SCG addition as soon as the L1 measurement report for MCG cell change is sent to gNB1. In operation 17-5A (Alt2), the UE 202 continues measuring LTM events for SCG addition but does not send the measurement report to gNB after the event condition is satisfied. In operation 17-6, the UE 202 sends L1 measurement report to gNB for the LTM event (MCG). In operation 17-7 (Alt1), the UE 202 stops measurement of LTM events for SCG addition. In operation 17-8 (Alt2), the UE 202 continues LTM SCG addition event measurement but does not send the measurement report to gNB. In operation 17-9, the MAC CE for handover to target cell is performed by the UE 202. In operation 17-10, the UE 202 hands over to target Cell-B (gNB3 212A). In operation 17-11, unnecessary signaling for SCG addition and data split threshold reset is avoided by the UE 202, since the SCG cell is not added and the UE 202 soon gets handed over to the neighbor cell.

In an instance, consider the scenario that the UE 202 is connected with the MCG cell and no SCG cell is added. The network may configure the UE 202 with LTM events (e.g., LTM3) for MCG change (handover) and LTM events (e.g., LTM4) for SCG addition, along with their respective configurations, at the same time. The UE 202 performs measurements for both events independently. If any LTM event for MCG cell change is fulfilled before the LTM event for SCG addition, the UE 202 sends an L1 measurement report to the gNB and waits for the gNB to trigger handover to the LTM candidate cell through MAC CE. Therefore, the UE 202 stop measuring LTM events for SCG addition, since SCG configuration and associated conditions will no longer be valid once the UE 202 moves to the target cell after a gNB-triggered handover. Thus, if the UE 202 performs SCG measurements, the MCG change may occur earlier as the L1 measurement report for MCG has already been sent, and if the SCG is added before MCG change, the SCG cell will be lost as soon as the gNB triggers handover to the LTM candidate cell.

As an alternate embodiment, the UE 202 may continue measuring the LTM event for SCG addition but avoid sending the L1 measurement report for SCG addition while waiting for the gNB to trigger handover to the neighbor cell. For enhancement, the back-off timer may be used, which starts after the UE 202 sends the L1 measurement report for the MCG candidate cell handover. During the timer period, the UE 202 suspends SCG-related actions such as measurements or sending the L1 report for SCG addition. The back-off timer may be a configurable value in the UE 202 or provided by the network to prevent SCG addition and deletion within a short time. Therefore, the proposed method allows the UE 202 to avoid unnecessary SCG measurements and signaling overhead, leading to power optimization, prevents the momentary SCG addition and deletion within a short span. Thereby avoiding data stalls or drops in data rate, since PDCP re-establishment is not triggered and the data split ratio is not reset.

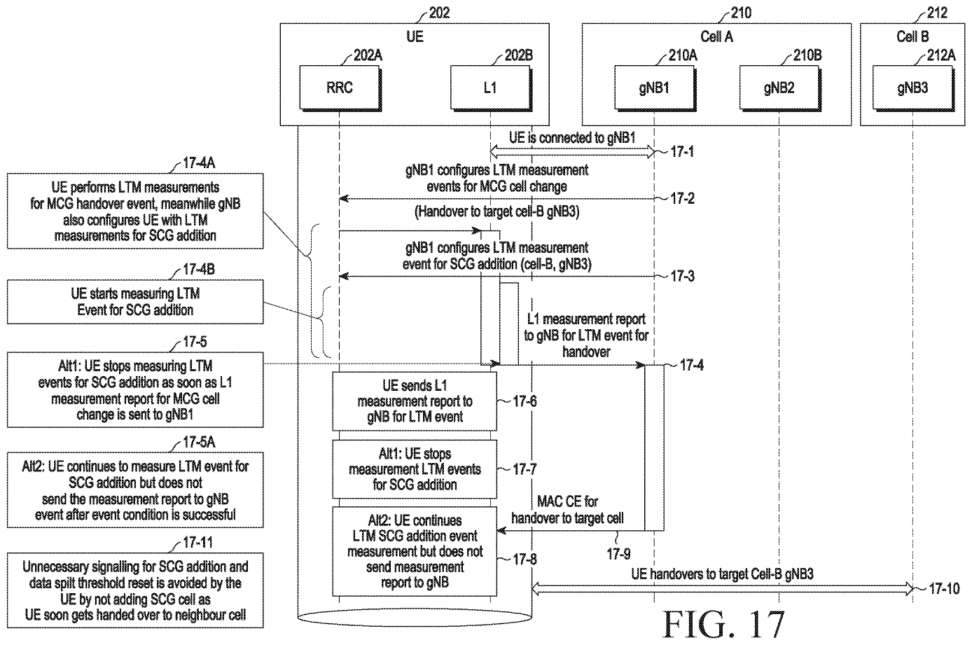

FIG. 18 is an example flow diagram illustrating the coexistence of conditional SCG addition and LTM MCG change with timer according to an embodiment of the disclosure.

Referring to FIG. 18, in operation 18-1, the UE 202 (e.g., RRC 202A and L1 202B) is connected with the serving gNB1 210A. In operation 18-2, the gNB1 210A configures LTM measurement events for MCG cell change (handover to target Cell-B 212, gNB3 212A). In operation 18-3, the gNB1 210A also configures LTM measurement event for SCG addition (Cell-B 212, gNB3 212A). In operation 18-4, the UE 202 sends L1 measurement report to gNB for LTM event for handover. In operation 18-4A, the UE 202 performs LTM measurements for the MCG handover event, while gNB also configures UE 202 with LTM measurements for SCG addition. In operation 18-4B, the UE 202 starts measuring the LTM event for SCG addition. In operation 18-5, the UE 202 sends L1 measurement report to gNB for LTM event and starts a timer to receive handover command. In operation 18-5A (Alt1), the UE 202 stops measuring the LTM event for SCG addition as soon as the L1 measurement report for MCG cell change is sent to gNB1. The UE 202 starts a timer to receive the handover command from the network. If the handover command is not received before timer expiry, the UE 202 restarts measurement for the LTM SCG event.

In operation 18-5B (Alt2), the UE 202 continues measuring the LTM event for SCG addition but does not send the measurement report to gNB even if the condition is satisfied. The UE 202 starts a timer to receive the handover command from the network. If the handover command is not received before timer expiry and the LTM SCG condition is still satisfied, the UE 202 sends the measurement report for SCG addition. In operation 18-6 (Alt1), the UE 202 stops measurement of LTM events for SCG addition until timer expiry. In operation 18-7 (Alt2), the UE 202 continues LTM SCG addition event measurement but does not send the measurement report to gNB until timer expiry. In operation 18-8, the MAC CE for handover to target cell is performed by the UE 202. In operation 18-9, the UE 202 hands over to target Cell-B (gNB3 212A). In operation 18-10, by avoiding SCG addition, unnecessary signaling for SCG addition and data split threshold resets are prevented, since the UE 202 soon hands over to the neighbor cell.

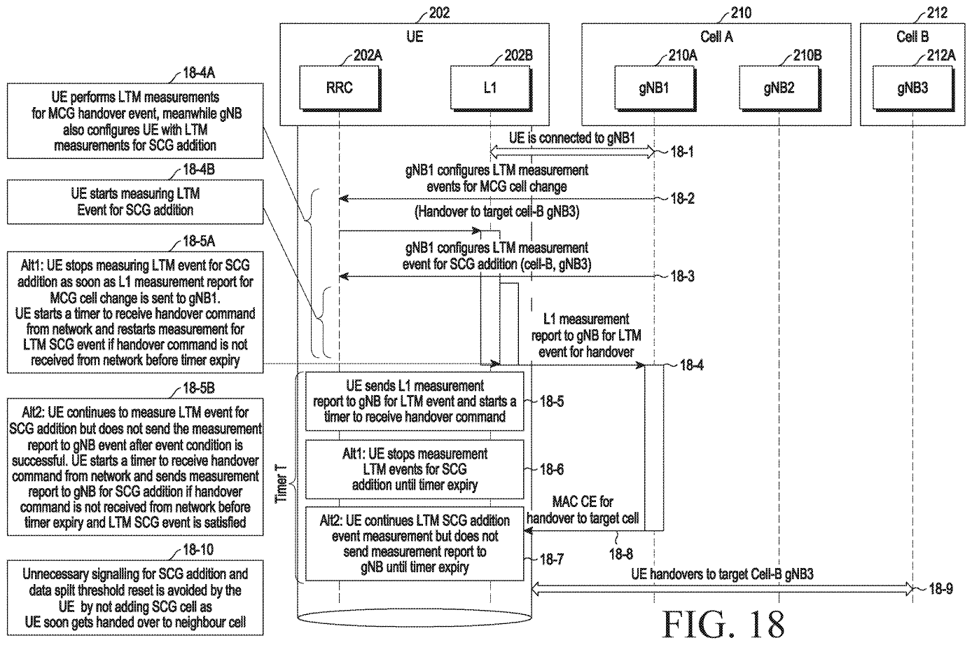

FIG. 19 is an example diagram 1900 illustrating the UE 202 stops measuring or sending report for LTM SCG event while waiting for handover command according to an embodiment of the disclosure.

Referring to FIG. 19, in operation 1902, the UE 202 is connected to the gNB, wherein the gNB configures LTM events for handover and LTM event for SCG addition. In operation 1904, the UE 202 performs measurements for LTM event for handover and SCG addition. In operation 1906, the LTM event for handover is satisfied and the UE 202 is performing measurements for LTM SCG addition event. In operation 1908, the UE 202 checks whether the LTM SCG addition event is satisfied or not. In operation 1912, on satisfying the condition, in alt1, the UE 202 stops performing measurements for SCG addition LTM event and delete LTM measurement config SCG addition. In alt2, the UE 202 keeps performing measurements for LTM SCG addition, but does not send measurement report to gNB. In operation 1910, the UE 202 do not send L1 measurement reports to gNB for SCG addition event on not satisfying the condition. Hence, the UE 202 stops measuring or sending report for LTM SCG event while waiting for handover command.

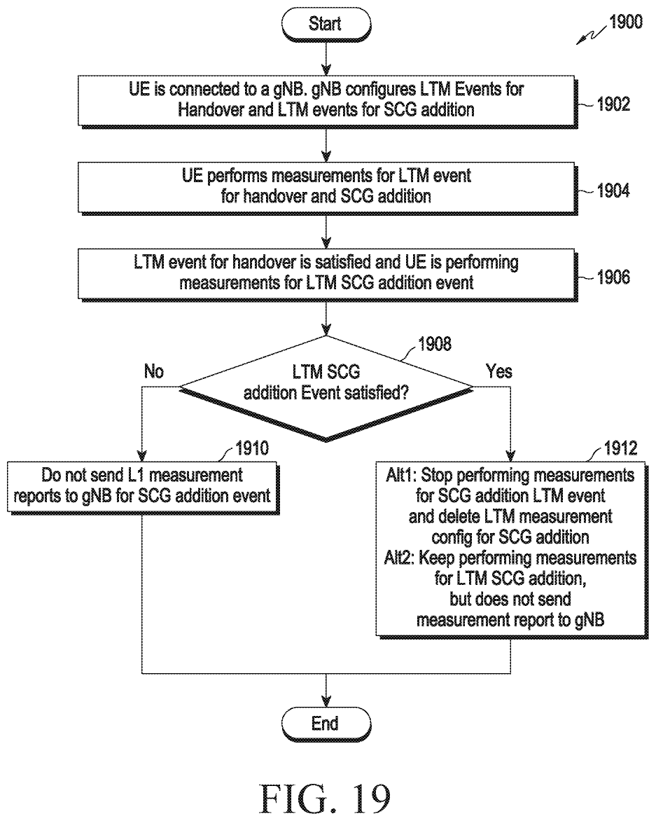

FIG. 20 is an example diagram 2000 illustrating the UE 202 stops measuring or sending report for LTM SCG event while waiting for handover command until back-off timer expiry according to an embodiment of the disclosure.

In operation 2002, the UE202 is connected to the gNB, wherein the gNB configures the LTM events for the handover and LTM events for SCG addition. In operation 2004, the UE 202 performs measurements for LTM event for handover and SCG addition. In operation 2006, the LTM event for handover is satisfied and the UE 202 is performing measurements for LTM SCG addition event. In operation 2008, the UE 202 starts a timer for receiving LTM handover command in MAC CE. In operation 2010, the UE 202 may check whether the LTM SCG addition event condition is satisfied or not, on satisfying the condition in operation 2012, the UE 202 does not send LTM measurement report to gNB for SCG addition. On not satisfying the condition, in operation 2014, alt1, wherein the UE 202 stops performing measurements for LTM event. In alt2, the UE 202 keeps measuring LTM event condition but do not send LTM SCG addition measurement report even if event is satisfied. In operation 2016, the MAC CE is received, in operation 2018, the UE 202 on receiving the MAC CE, the UE 202 may discard the LTM SCG event configurations. In operation 2020, timer on expired, in alt1, the UE 202 performs continuous measurement for LTM event condition and send measurement report if the condition is satisfied. In alt1, the UE 202 may send LTM SCG addition event measurement report if the event condition was satisfied earlier. Hence, the UE 202 stops measuring or sending report for LTM SCG event while waiting for handover command until back-off timer expiry.

In an instance, consider a scenario, where the UE 202 is connected with the MCG cell and no SCG cell is added. The network may configure the UE 202 with C-LTM SCG configuration along with execution conditions for SCG addition, as well as LTM events (e.g., LTM3/LTM5) for MCG change (handover) at the same time. The UE 202 performs measurements for both events independently. When any LTM event for MCG change is fulfilled before the C-LTM SCG addition event, the UE 202 sends an L1 measurement report to the gNB and waits for the gNB to trigger handover to the LTM candidate cell through MAC CE. The UE 202 stop measuring C-LTM execution conditions for SCG addition, since the configurations and conditions will no longer be valid once the UE 202 moves to the target cell after gNB-triggered handover. Thus, even if the SCG addition conditions for C-LTM are satisfied and the UE 202 applies the target SCG configuration, the added SCG cell will be lost immediately when the gNB triggers handover to the LTM candidate cell. As an alternate method, the UE 202 may continue measuring C-LTM conditions for SCG addition but avoid applying the associated configuration while waiting for the gNB to trigger handover to the neighbor cell. For further enhancement, the back-off timer is used, which starts after the UE 202 sends the L1 measurement report for the MCG candidate cell handover. During timer period, the UE 202 suspends SCG-related actions, such as performing measurements or applying configuration for SCG addition, until the timer expires. The back-off timer may be a configurable parameter in the UE 202 or set by the network to avoid rapid SCG addition and deletion within a short time. Therefore, avoids unnecessary SCG measurements, reduces signaling overhead, and leads to power optimization. It prevents momentary SCG addition and deletion in a short span of time, helping the UE 202 maintain stable data rates without PDCP re-establishment or data split ratio reset.

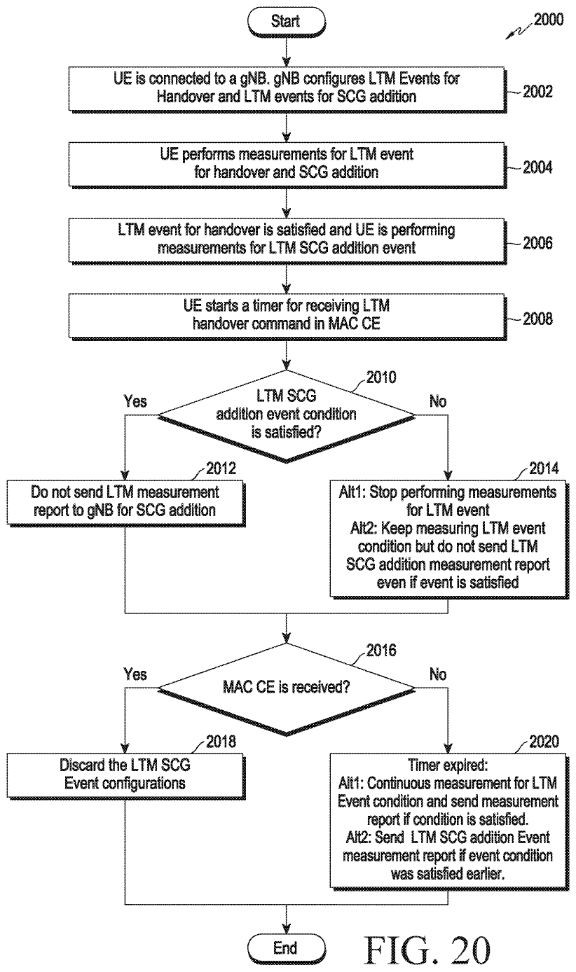

FIG. 21 is an example flow diagram illustrating the coexistence of C-LTM based SCG addition and LTM MCG change without timer according to an embodiment of the disclosure.

Referring to FIG. 21, in operation 21-1, the UE 202 (e.g., RRC 202A and L1 202B) is connected with the serving gNB1 210A. In operation 21-2, the gNB1 210A configures LTM measurement events for MCG cell change (handover to target Cell-B 212, gNB3 212A). In operation 21-3, the gNB1 also configures C-LTM configuration and execution condition for SCG addition (Cell-A, gNB2). In operation 21-4, the UE 202 sends the L1 measurement report to gNB for LTM event for MCG cell change. In operation 21-4A, the UE 202 measures C-LTM associated execution condition for SCG addition. In operation 21-5 (Alt1), the UE 202 stops measuring C-LTM execution condition for SCG addition as soon as the L1 measurement report for MCG cell change is sent to gNB. In operation 21-5A (Alt2), the UE 202 continues evaluating C-LTM execution conditions for SCG addition but does not apply SCG configuration even if the evaluation is successful. In operation 21-6, the UE 202 sends the L1 measurement report to gNB for the LTM (MCG) event. In operation 21-7 (Alt1), the UE 202 stops measurement of C-LTM execution conditions. In operation 21-7A (Alt2), the UE 202 continues C-LTM evaluation but does not apply the configuration for SCG addition. In operation 21-8, the MAC CE for handover to target cell is performed by the UE 202. In operation 21-9, the UE 202 hands over to target Cell-B (gNB3), and no SCG cell is lost. In operation 21-10, by avoiding SCG addition, the UE 202 prevents unnecessary signaling and data split threshold resets, since the UE 202 soon gets handed over to the neighbor cell.

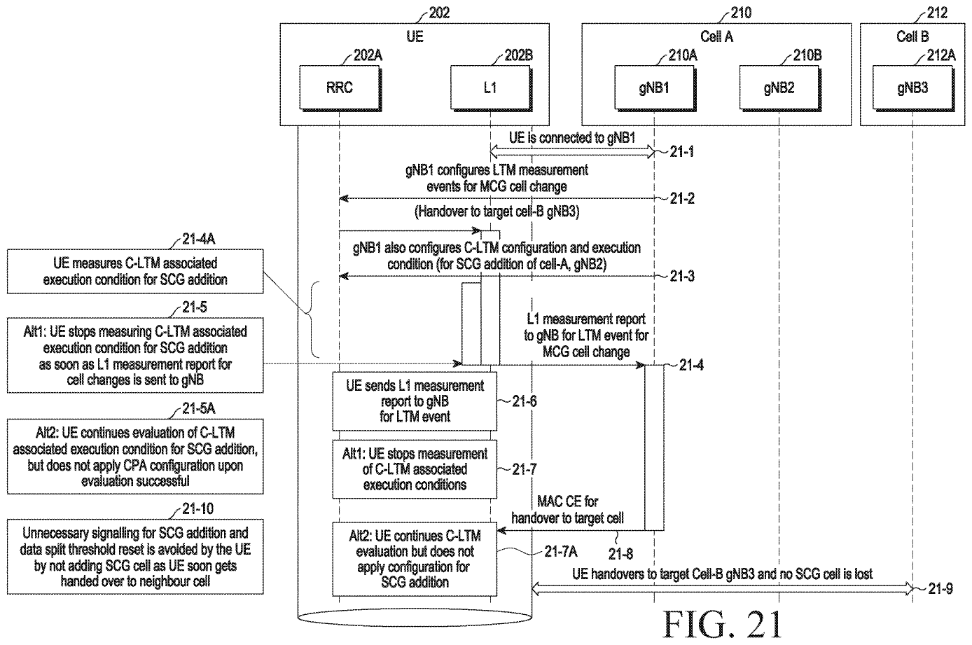

FIG. 22 is an example flow diagram illustrating the coexistence of conditional LTM based SCG addition and LTM MCG change with timer based according to an embodiment of the disclosure.

Referring to FIG. 22, in operation 22-1, the UE 202 (e.g., RRC 202A and L1 202B) is connected with the serving gNB1 210A. In operation 22-2, the gNB1 210A configures LTM measurement events for MCG cell change (handover to target Cell-B 212, gNB3 212A). In operation 22-3, the gNB1 also configures C-LTM configuration and execution condition for SCG addition (Cell-A, gNB2). In operation 22-4, the UE 202 sends the L1 measurement report to gNB for LTM event for MCG cell change. In operation 22-4A, the UE 202 measures C-LTM associated execution condition for SCG addition.

In operation 22-5 (Alt1), the UE 202 stops measuring C-LTM execution condition for SCG addition as soon as the L1 measurement report for MCG cell change is sent to gNB. The UE 202 starts a timer to receive the handover command from the network. If the handover command is not received before timer expiry, the UE 202 restarts measurement. In operation 22-5A (Alt2), the UE 202 continues evaluating C-LTM execution conditions for SCG addition but does not apply the configuration even if evaluation is successful. The UE 202 starts a timer to receive the handover command from the network. If the handover command is not received before timer expiry and the condition is still satisfied, the UE 202 applies the SCG configuration. In operation 22-6, the UE 202 sends L1 measurement report to gNB for the LTM event and starts a timer for handover command. In operation 22-7A (Alt1), the UE 202 stops measurement of C-LTM execution conditions for SCG addition until timer expiry. In operation 22-7B (Alt2), the UE 202 continues C-LTM evaluation but does not apply configuration for SCG addition until timer expiry. In operation 22-8, the MAC CE for handover is sent to the target cell. In operation 22-9, the UE 202 hands over to target Cell-B (gNB3), and no SCG cell is lost. Finally, in operation 22-10, by not adding the SCG cell, unnecessary signaling and data split threshold resets are avoided, since the UE 202 soon gets handed over to the neighbor cell.

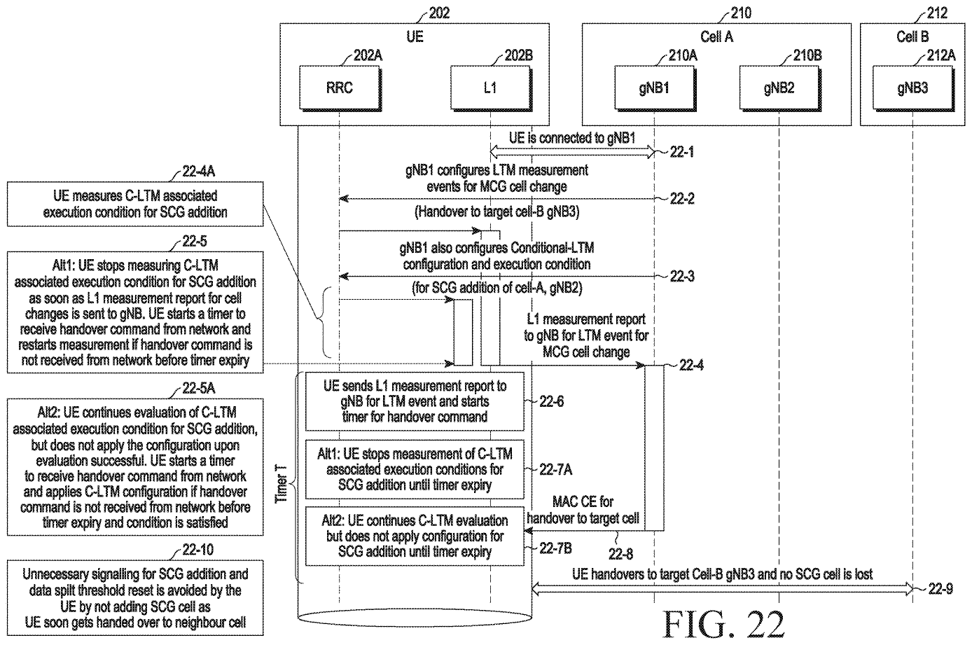

FIG. 23 is an example diagram 2300 illustrating the UE 202 stops measuring or applying C-LTM configuration for SCG addition while waiting for Handover command according to an embodiment of the disclosure.

Referring to FIG. 23, in operation 2302, the UE 202 is connected to the gNB, wherein the gNB configures LTM events for handover. The gNB configures C-LTM configuration and associated execution condition for SCG addition. In operation 2304, the UE 202 performs measurements for LTM events for handover and C-LTM associated execution conditions. In operation 2306, the LTM event for handover is satisfied and the UE 202 performs measurement C-LTM execution condition for SCG addition. In operation 2308, the UE 202 checks whether C-LTM for SCG associated execution condition is satisfied or not, in operation 2310, on satisfying the condition, the UE 202 do not apply configuration for SCG addition. In operation 2312, alt1, the UE 202 stops performing measurements for C-LTM execution condition for SCG addition and delete C-LTM config and associated execution conditions. Alt2, the UE 202 keeps evaluating C-LTMM execution condition for SCG addition but do not apply the configuration if evaluation is successful.

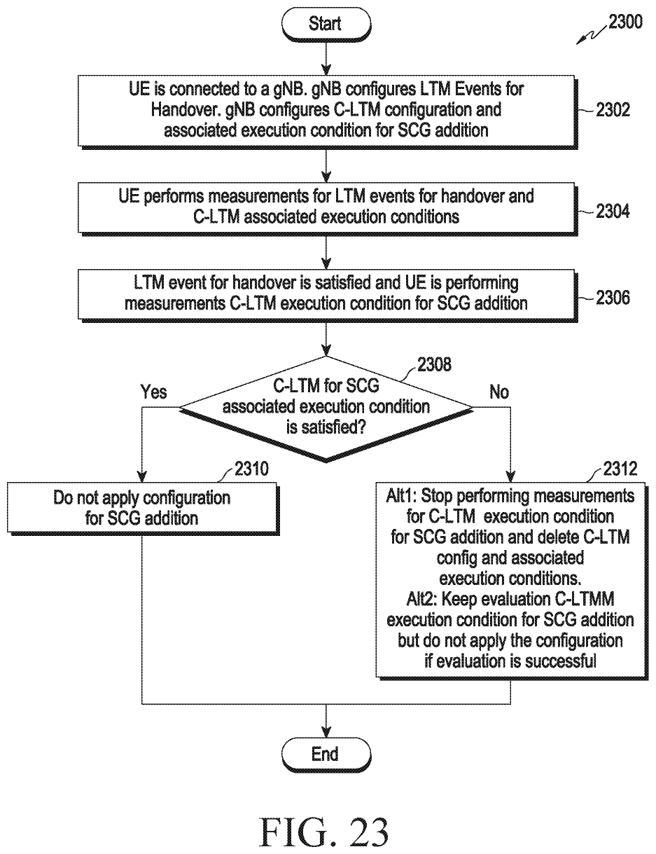

FIG. 24 is an example diagram 2400 illustrating the UE 202 stops measurement/applying C-LTM configuration for SCG addition while waiting for handover command until back-off timer expiry according to an embodiment of the disclosure.

Referring to FIG. 24, in operation 2402, the UE 202 is connected to the gNB, wherein the gNB configures LTM events for handover. The gNB also configures C-LTM configuration and associated execution condition for SCG addition. In operation 2404, the UE 202 performs measurements for LTM event for handover and C-LTM execution conditions for SCG addition. In operation 2406, the LTM event for handover is satisfied and the UE 202 is performing measurements for C-LTM execution condition for SCG addition. In operation 2408, the UE 202 starts a timer for receiving LTM handover command in MAC CE. In operation 2410, the UE 202 checks whether C-LTM for SCG associated execution condition is satisfied or not. In operation 2412, on satisfying the condition, the UE 202 does not apply C-LTM configuration for SCG addition until expiry of timer. In operation 2414, alt1, the UE 202 stops performing measurements for C-LTM execution condition for SCG addition. Alt2. The UE 202 keeps evaluating associated execution condition but do not apply C-LTM configuration if the evaluation is successful. In operation 2416, the MAC CE is received, in operation 2418, on receiving the MAC CE, the UE 202 discards the C-LTM configuration and associated execution condition. In operation 2420, on timer expired, alt1, the UE 202 continue measurement for C-LTM execution condition and apply configuration once evaluation is successful. In alt2, the UE 202 applies C-LTM configuration for SCG addition if associated execution condition was successful earlier.

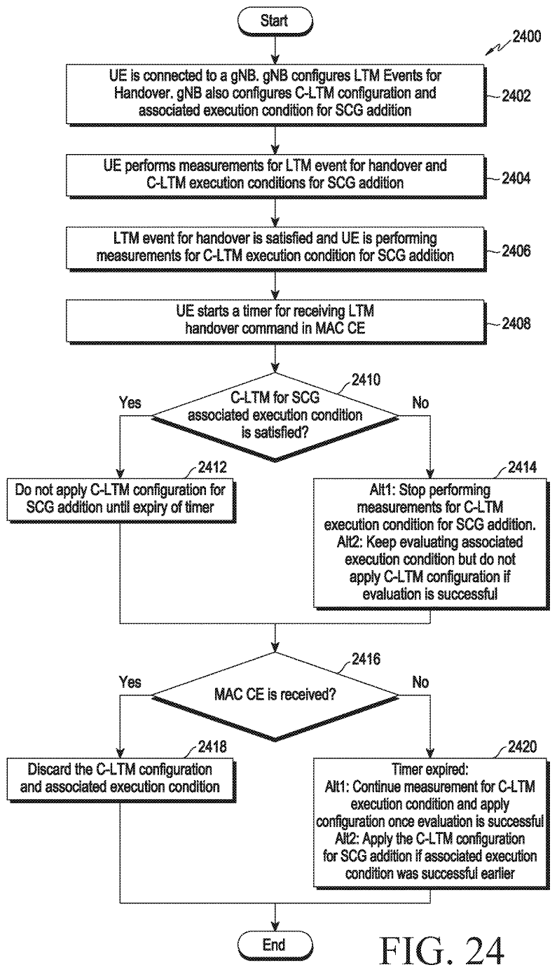

FIG. 25 is an example diagram illustrating hardware components of the UE 202 for handling the handover in the wireless communication network according to an embodiment of the disclosure.

Referring to FIG. 25, in an embodiment, the UE 202 includes a processor 214 and memory 216. The processor 214 is coupled with the memory 216.

The processor 214 receives the LTM configuration message to perform the MCG cell change from the first network entity 220. The LTM configuration message indicates the handover of the UE 202 to the second network entity associated with a target cell. The first network entity 220 is associated with a source cell. Further, the processor 214 receives the SCG addition message from the first network entity 220. The SCG addition message includes at least one of: the PSCell addition configuration and the conditional execution event (CPA) associated with the PSCell addition configuration, a configuration for the PSCell addition and the LTM execution condition associated with the configuration, and a configuration for the PSCell addition and the conditional LTM execution condition associated with the configuration. Further, the processor 214 measures and sends the MCG measurement report for handover and stopping a measurement event and execution of the associated SCG cell. Further, the processor 214 performs the handover of the UE 202 to the second network entity based on handover information.

Further, the processor 214 stops measurement of the execution condition associated with the CPA configuration in response to sending the MCG measurement report for the LTM event. In an embodiment, the processor 214 stops measurement of the LTM event for SCG addition in response to sending the MCG measurement report for the LTM event. In an embodiment, the processor 214 stops measurement of the C-LTM event for SCG addition in response to sending the MCG measurement report for the LTM event. In an embodiment, the processor 214 stops measurement of the LTM event for SCG addition until expiry of the timer in response to sending the MCG measurement report for the LTM event. In an embodiment, the processor 214 stops measurement of the CPA until expiry of the timer, in response to sending the MCG measurement report for the LTM event. In an embodiment, the processor 214 stops measurement of the C-LTM event for SCG addition until expiry of a timer in response to sending the MCG measurement report for the LTM event.

In an embodiment, the processor 214 stops executing SCG addition on identifying that the SCG addition event is satisfied for the execution condition associated with the CPA configuration in response to sending the MCG layer measurement report for the LTM event. The layer measurement report indicates that an LTM event has been satisfied to trigger the MCG cell change. The SCG Addition event includes at least one of: CPAC event, an LTM event for SCG addition or C-LTM event for SCG addition.

In an embodiment, the processor 214 stops sending the measurement event of the LTM event identifying that the SCG addition event is satisfied for LTM SCG addition event in response to sending the MCG layer measurement report for the LTM event. In an embodiment, the processor 214 stops executing SCG addition on identifying that C-LTM event for SCG addition is satisfied in response to sending the MCG layer measurement report for the LTM event. In an embodiment, the processor 214 stops executing SCG addition on identifying that the SCG addition event is satisfied for the execution condition associated with the CPA configuration in response to sending the MCG measurement report for the LTM event until expiry of a timer. In an embodiment, the processor 214 stops sending the measurement event of the LTM event identifying that the SCG addition event is satisfied for LTM SCG addition event in response to sending the MCG measurement report for the LTM event until expiry of the timer. In an embodiment, the processor 214 stops stopping executing SCG addition on identifying that C-LTM event for SCG addition is satisfied in response to sending the MCG measurement report for the LTM event until expiry of the timer.

In an embodiment, the processor 214 stops measurement of at least one of the CPA, the LTM event and the C-LTM event for SCG addition until an expiry of a timer in response to sending the MCG measurement report for the LTM event on at least one of the infinite or time bound and until expiry of the timer.

In an embodiment, the processor 214 performs measurement of at least one of the CPA, the LTM event and the C-LTM event for SCG addition and stops executing SCG addition on identifying that the SCG addition event is satisfied based on at least one of the infinite or time bound and until expiry of the timer.

In an embodiment, the processor 214 receives the LTM configuration message to perform the MCG change from the network entity 220, when the network entity 220 configures at least one LTM measurement event for the MCG cell change.

In an embodiment, the processor 214 receives the LTM configuration message and conditions for candidate MCG change from the network entity 220. Further, the processor 214 receives at least one of: a conditional handover message including conditional PSCell addition (CPA) configuration and execution condition; an LTM execution message including PSCell addition configuration and LTM execution condition; and an LTM execution message including PSCell addition configuration and C-LTM execution condition.

Further, the processor 214 measures the candidate cell of the MCG change configuration condition. Further, the processor 214 measures and evaluates at least one of: the CPA configuration condition; LTM Event for PSCell addition configuration conditions; and C-LTM Event for PSCell Addition Configuration conditions. Further, the processor 214 sends the L1 measurement report for the LTM to the network entity. Further, the processor 214 stops measurement of CPA associated execution condition.

The processor 214 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 214 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 214 may include multiple cores and is configured to execute the instructions stored in the memory 216.

Further, the processor 214 is configured to execute instructions stored in the memory 216 and to perform various processes. A communicator (not shown) is configured for communicating internally between internal hardware components and with external devices via one or more networks. The memory 216 also stores instructions to be executed by the processor 214. The memory 216 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 216 may, in some examples, be considered a non-transitory storage medium. The term “non-transitory” may indicate that the storage medium is not embodied in a carrier wave or a propagated signal. However, the term “non-transitory” should not be interpreted that the memory 216 is non-movable. In certain examples, a non-transitory storage medium may store data that may, over time, change (e.g., in Random Access Memory (RAM) or cache).

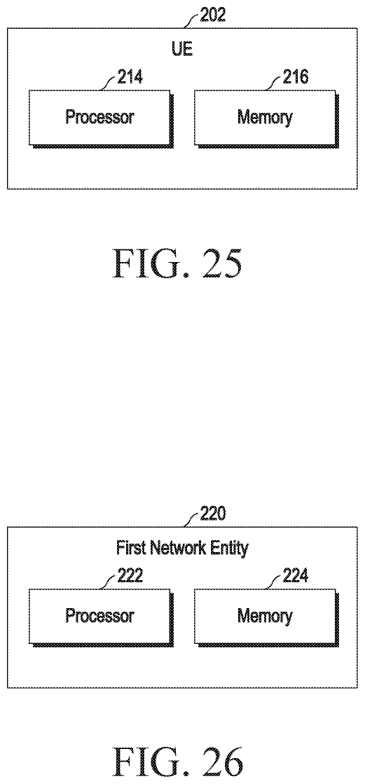

FIG. 26 is an example diagram illustrating hardware components of the first network entity 220, for handling the handover of the UE 202 in the wireless communication network according to an embodiment of the disclosure.

Referring to FIG. 26, in an embodiment, the first network entity 220 includes a processor 222 and memory 224. The processor 222 is coupled with the memory 224.

The processor 222 sends the LTM configuration message to perform the MCG cell change to the UE 202. Further, the processor 222 sends the SCG addition message to the UE 202. The SCG addition message includes at least one of: the PSCell addition configuration and the CPA associated with the PSCell addition configuration, a configuration for the PSCell addition and the LTM execution condition associated with the configuration, and a configuration for the PSCell addition and a conditional LTM execution condition associated with the configuration. Further, the processor 222 receives an MCG measurement report for handover from the UE 202 based on the LTM configuration message. Further, the processor 222 sends the handover information to the UE 202 based on the MCG measurement report.

The processor 222 is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor 222 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 222 may include multiple cores and is configured to execute the instructions stored in the memory 224.

Further, the processor 222 is configured to execute instructions stored in the memory 224 and to perform various processes. A communicator (not shown) is configured for communicating internally between internal hardware components and with external devices via one or more networks. The memory 224 also stores instructions to be executed by the processor 222. The memory 224 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 224 may, in some examples, be considered a non-transitory storage medium. The term “non-transitory” may indicate that the storage medium is not embodied in a carrier wave or a propagated signal. However, the term “non-transitory” should not be interpreted that the memory 224 is non-movable. In certain examples, a non-transitory storage medium may store data that may, over time, change (e.g., in Random Access Memory (RAM) or cache).

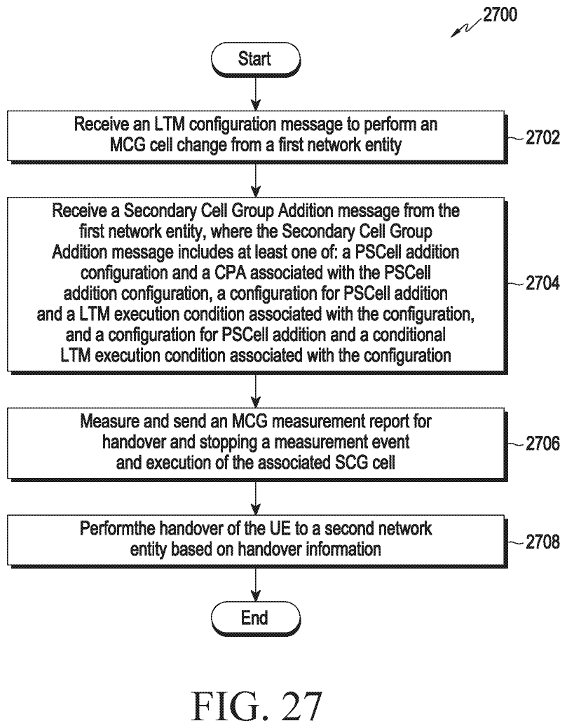

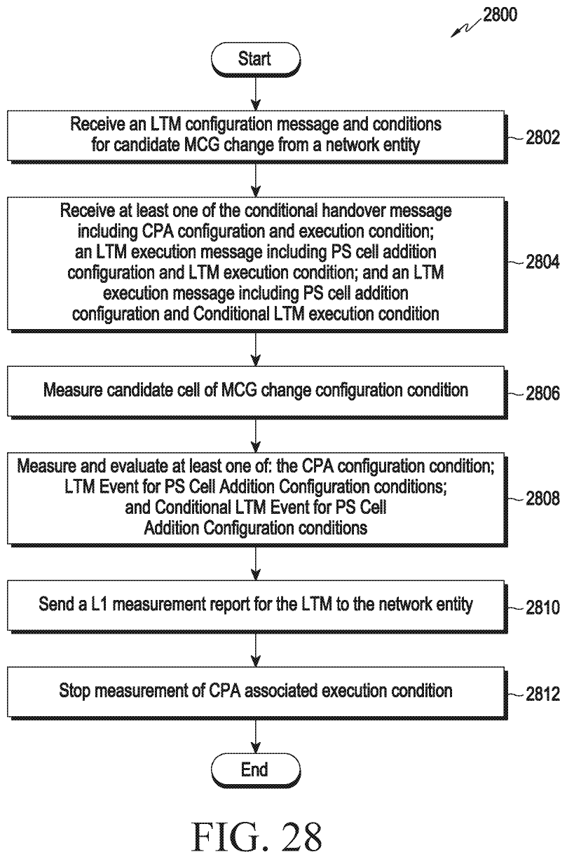

FIGS. 27 and 28 are example flow diagrams 2700 and 2800 depicting a method for handling a handover of the UE 202 in the wireless network according to various embodiments of the disclosure.

Referring to FIG. 27, the operations 2702 and 2708 are handled by the processor 214. In operation 2702, the method includes receiving the LTM configuration message to perform the MCG cell change from the first network entity. In operation 2704, the method includes receiving the SCG addition message from the first network entity 220. The SCG addition message includes at least one of: the PSCell addition configuration and the CPA associated with the PSCell addition configuration, the configuration for the PSCell addition and the LTM execution condition associated with the configuration, and the configuration for the PSCell addition and the conditional LTM execution condition associated with the configuration.

In operation 2706, the method includes measuring and sending, by the UE 202, an MCG measurement report for handover and stopping a measurement event and execution of the associated SCG cell. In operation 2708, the method includes performing, by the UE 202, the handover of the UE 202 to a second network entity based on handover information.

Referring to FIG. 28, the operations 2802 and 2812 are handled by the processor 222. In operation 2802, the method includes receiving the LTM configuration message and conditions for candidate the MCG change from a network entity. In operation 2804, the method includes receiving the at least one of the conditional handover message including CPA configuration and execution condition; an LTM execution message including PSCell addition configuration and LTM execution condition; and an LTM execution message including PSCell addition configuration and C-LTM execution condition. In operation 2806, the method includes measuring the candidate cell of the MCG change configuration condition.

In operation 2808, the method includes measuring and evaluating at least one of: the CPA configuration condition; LTM Event for PSCell addition configuration conditions; and conditional LTM Event for PSCell addition configuration conditions. In operation 2810, the method includes sending the L1 measurement report for the LTM to the network entity. In operation 2812, the method includes stopping the measurement of CPA associated execution condition.

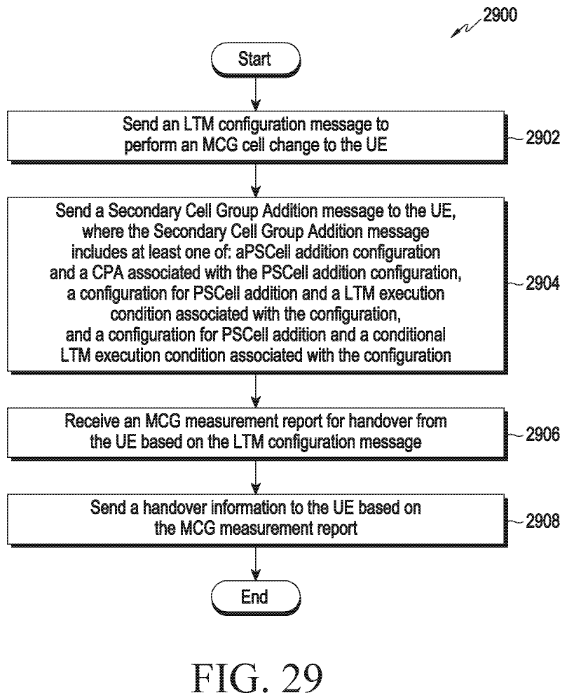

FIG. 29 is an example flow diagram 2900 depicting a method for handling the handover of the UE 202 in the wireless network, by the first network entity 220 according to an embodiment of the disclosure. The operations 2902 and 2908 are handled by the processor 222.

In operation 2902, the method includes sending the LTM configuration message to perform the MCG cell change to the UE 202. In operation 2904, the method includes sending the SCG addition message to the UE 202. The SCG addition message includes at least one of: the PSCell addition configuration and the CPA associated with the PSCell addition configuration, the configuration for the PSCell addition and the LTM execution condition associated with the configuration, and the configuration for PSCell addition and a conditional LTM execution condition associated with the configuration. In operation 2906, the method includes receiving the MCG measurement report for handover from the UE 202 based on the LTM configuration message. In operation 2908, the method includes sending the handover information to the UE 202 based on the MCG measurement report.

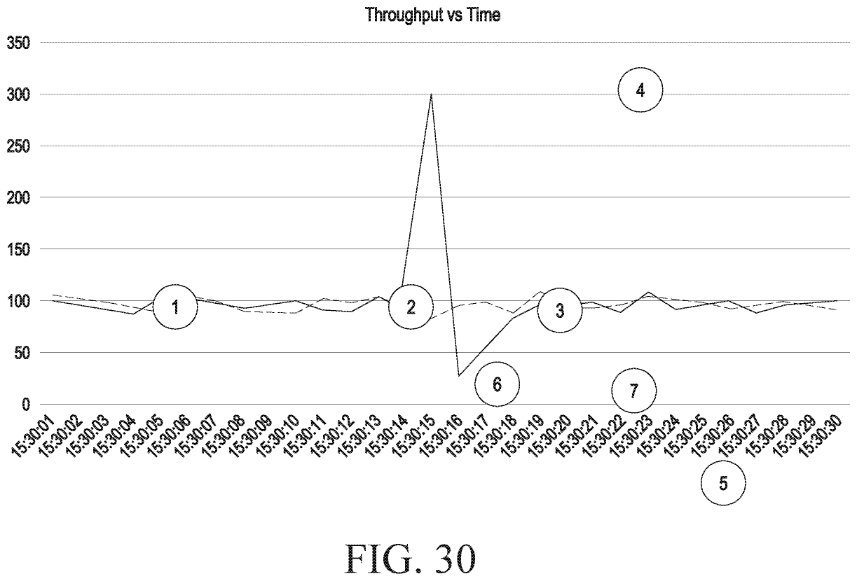

FIG. 30 is an example graph diagram illustrating the user experience with data throughput against time according to an embodiment of the disclosure.

Referring to FIG. 30, the curve at first position (1) describes that the network provides LTM and CPA configurations to UE 202 for MCG change and SCG addition respectively. As illustrated in the graph, the curve at the second position (2) provides LTM L1 measurement sent by the UE 202 for MCG change and the UE 202 waiting for handover command from the network. The curve at the third position (3) describes the CPA condition is satisfied and the UE 202 applies the configuration for SCG addition. At the fourth position (4) of the curve provides throughput increases momentarily as SCG is added. At fifth position (5), the gNB triggers handover of the UE 202 based on L1 measurement report sent by the UE 202 and SCG is lost immediately. Throughput drops due to data path reset. At the sixth position (6), the proposed method discloses about the UE 202 which stops CPA measurement upon sending L1 measurement report for MCG change. At the seventh position (7), the proposed method discloses throughput remains steady as no SCG addition is performed and removal takes place during handover.

An embodiment as disclosed herein, the UE 202 stops SCG measurements after transmitting the L1 report of the MCG, and therefore the SCG will not be added. The data path is consistently maintained on the MCG leg. Based on the L1 report of the MCG, the gNB will trigger the handover, resulting in an MCG cell switch. The momentary SCG addition and deletion are avoided, enabling the UE 202 to maintain a consistent data flow and prevent data fluctuations. Hence, the proposed method ensures data stability, as the data path is maintained consistently, thereby enhancing the user experience.

The proposed method may be used to prevent the measurements for SCG event associated with CPA addition or LTM event of SCG candidate cell and stops momentary SCG addition after the UE 202 sends LTM based measurement report for MCG cell change and waiting for cell switch command. The scenario of getting MCG change via the LTM and SCG addition through CPA or LTM is quite possible to happen as the network may configure this events independently based on specification and RAN 2 agreements. The proposed method may be used to prevent unnecessary measurements of SCG cell and the proposed method may be used to avoid the momentary SCG addition in this scenario. proposed method may be used to save the power and avoids data stall experience.

Based on the proposed method, the UE 202 will stop measuring CPA associated execution conditions of SCG candidate cell for conditional SCG addition or stops measurements of LTM events for SCG candidate cell for LTM SCG event while waiting for cell switch command as SCG configuration and its conditions will not be valid once the UE 202 moves to target cell based on gNB triggered handover to LTM candidate cell.

The proposed method may be used to prevent the unnecessary measurements of SCG cell and signaling overhead and leads to power saving and power optimization. The proposed method may be used to avoid the momentary SCG addition and deletion which gains the UE 202 to avoid experience data stall or drop in data rate as PDCP will not be re-established and leads to better user experience.

Based on the proposed method, the UE 202 will skip measuring CPA associated execution conditions of SCG candidate cell for conditional SCG addition or stops measurements of LTM events for SCG candidate cell for LTM SCG event while waiting for cell switch command as SCG configuration and its conditions will not be valid once the UE 202 moves to target cell based on gNB triggered handover to LTM candidate cell

The proposed method is based on the analysis that LTM events and measurements are configured along with their candidate cell configuration which is different from L3 measurements which is configured without candidate cells configuration, so sending measurement report for LTM candidate cells is targeted for the execution of candidate cells and extreme chance for the MCG change via MAC CE command will happen after the UE 202 sends measurement report for LTM MCG event.

The method may be used to stop measurements of SCG candidate cell for CHO/LTM/C-LTM event after the UE 202 sends L1 measurement report for MCG candidate cell and thus the UE 202 avoid unnecessary measurements of SCG cell and saves power consumption which enhances battery time and power optimization. The method may be used to avoids the momentary addition and deletion of SCG while the UE 202 waits for Handover command through MAC CE and thus the UE 202 avoids ping-pong of SCG Addition/Deletion and reestablishment of data path and so the UE 202 makes the consistent data activity and improves data stability which results in better user experience.

The method may be used to stop sending the measurement report for LTM SCG event after the UE 202 sends L1 measurement report of MCG candidate cell for the handover and thus the proposed method avoids signaling overhead and enhances power optimization in UE 202.

The various actions, acts, blocks, steps/operations, or the like in the flow charts/diagrams 2700, 2800, and 2900 may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein may be implemented through at least one software program running on at least one hardware device and performing network management functions to control the network elements. The elements include blocks which may be at least one of a hardware device, or a combination of hardware device and software module.

Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high-speed integrated circuit hardware description language (VHDL) another programming language, or implemented by one or more VHDL or several software modules being executed on at least one hardware device. The hardware device may be any kind of portable device that may be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for handling a handover of a user equipment (UE) in a wireless network, the method comprising:
receiving, by the UE, a layer trigger mobility (LTM) configuration message to perform a master cell group (MCG) cell change from a first network entity;
receiving, by the UE, a secondary cell group (SCG) addition message from the first network entity;
sending, by the UE, an MCG measurement report for handover and stopping a measurement event and an execution of an associated SCG cell; and
performing, by the UE, the handover to a second network entity based on handover information,
wherein the SCG addition message includes at least one of:
a primary secondary cell (PSCell) addition configuration and a conditional execution event (CPA) associated with the PSCell addition configuration,
the PSCell addition configuration and an LTM execution condition associated with the PSCell addition configuration, or
the PSCell addition configuration and a conditional LTM (C-LTM) execution condition associated with the PSCell addition configuration.

2. The method as claimed in claim 1, wherein the method further comprises performing, by the UE, at least one of:
stopping measurement of an execution condition associated with CPA configuration in response to sending the MCG measurement report for an LTM event;
stopping measurement of the LTM event for SCG addition in response to sending the MCG measurement report for the LTM event;
stopping measurement of a C-LTM event for SCG addition in response to sending the MCG measurement report for the LTM event;
stopping measurement of the LTM event for SCG addition until an expiry of a timer in response to sending the MCG measurement report for the LTM event;
stopping measurement of the CPA until the expiry of the timer, in response to sending the MCG measurement report for the LTM event; or
stopping measurement of the C-LTM event for SCG addition until the expiry of the timer in response to sending the MCG measurement report for the LTM event.

3. The method as claimed in claim 1, wherein the method further comprises performing, by the UE, at least one of:
stopping executing SCG addition on identifying that an SCG addition event is satisfied for an execution condition associated with CPA configuration in response to sending the MCG measurement report for an LTM event;
stopping sending the measurement event of the LTM event identifying that the SCG addition event is satisfied for LTM SCG addition event in response to sending the MCG measurement report for the LTM event;
stopping executing SCG addition on identifying that C-LTM event for SCG addition is satisfied in response to sending the MCG measurement report for the LTM event;
stopping executing SCG addition on identifying that the SCG addition event is satisfied for the execution condition associated with the CPA configuration in response to sending the MCG measurement report for the LTM event until an expiry of a timer;
stopping sending the measurement event of the LTM event identifying that the SCG addition event is satisfied for LTM SCG addition event in response to sending the MCG measurement report for the LTM event until the expiry of the timer; or
stopping executing SCG addition on identifying that C-LTM event for SCG addition is satisfied in response to sending the MCG measurement report for the LTM event until the expiry of the timer.

4. The method as claimed in claim 1, wherein the method further comprises stopping, by the UE, measurement of at least one of the CPA, an LTM event or a C-LTM event for SCG addition until an expiry of a timer in response to sending the MCG measurement report for the LTM event on at least one of infinite or time bound and until the expiry of the timer.

5. The method as claimed in claim 1, wherein the method further comprises performing, by the UE, measurement of at least one of the CPA, an LTM event or a C-LTM event for SCG addition and stopping executing SCG addition on identifying that an SCG addition event is satisfied based on at least one of infinite or time bound and until expiry of a timer.

6. The method as claimed in claim 1,
wherein the LTM configuration message indicates the handover of the UE to the second network entity associated with a target cell,
wherein the first network entity is associated with a source cell, and
wherein a first layer measurement report indicates that an LTM event has been satisfied to trigger the MCG cell change.

7. The method as claimed in claim 1, wherein the UE receives the LTM configuration message to perform the MCG cell change from the first network entity, wherein the first network entity configures at least one LTM measurement event for the MCG cell change.

8. The method as claimed in claim 1, wherein a SCG addition event includes at least one of:
conditional PSCell addition (CPAC) event, LTM event for SCG addition, or C-LTM event for SCG addition.

9. A method for handling a handover of a user equipment (UE) in a wireless network, the method comprising:
sending, by a first network entity, a layer trigger mobility (LTM) configuration message to perform a master cell group (MCG) cell change to the UE;
sending, by the first network entity, a secondary cell group (SCG) addition message to the UE;
receiving, by the first network entity, an MCG measurement report for handover from the UE based on the LTM configuration message; and
sending, by the first network entity, handover information to the UE based on the MCG measurement report,
wherein the SCG addition message includes at least one of:
a primary secondary cell (PSCell) addition configuration and a conditional execution event (CPA) associated with the PSCell addition configuration,
the PSCell addition configuration and an LTM execution condition associated with the PSCell addition configuration, or
the PSCell addition configuration and a conditional LTM execution condition associated with the PSCell addition configuration.

10. The method as claimed in claim 9,
wherein the LTM configuration message indicates the handover of the UE to a second network entity associated with a target cell,
wherein the first network entity is associated with a source cell, and
wherein a first layer measurement report indicates that an LTM event has been satisfied to trigger the MCG cell change.

11. A user equipment (UE), comprising:
memory, comprising one or more storage media, storing one or more computer programs; and
at least one processor communicatively coupled with the memory,
wherein the one or more computer programs include computer-executable instructions that, when executed by the at least one processor individually or collectively, cause the UE to:
receive a layer trigger mobility (LTM) configuration message to perform a master cell group (MCG) cell change from a first network entity;
receive a secondary cell group (SCG) addition message from the first network entity;
send an MCG measurement report for handover and stopping a measurement event and an execution of an associated SCG cell; and
perform the handover to a second network entity based on handover information,
wherein the SCG addition message includes at least one of:
a primary secondary cell (PSCell) addition configuration and a conditional execution event (CPA) associated with the PSCell addition configuration,
the PSCell addition configuration and an LTM execution condition associated with the PSCell addition configuration, or
the PSCell addition configuration and a conditional LTM execution condition associated with the PSCell addition configuration.

12. The UE as claimed in claim 11, wherein the one or more computer programs, when executed by the at least one processor individually or collectively, cause the UE to at least one of:
stop measurement of an execution condition associated with CPA configuration in response to sending the MCG measurement report for an LTM event;
stop measurement of the LTM event for SCG addition in response to sending the MCG measurement report for the LTM event;
stop measurement of a C-LTM event for SCG addition in response to sending the MCG measurement report for the LTM event;
stop measurement of the LTM event for SCG addition until an expiry of a timer in response to sending the MCG measurement report for the LTM event;
stop measurement of the CPA until the expiry of the timer, in response to sending the MCG measurement report for the LTM event; or
stop measurement of the C-LTM event for SCG addition until expiry of the timer in response to sending the MCG measurement report for the LTM event.

13. The UE as claimed in claim 11, wherein the one or more computer programs, when executed by the at least one processor individually or collectively, cause the UE to at least one of:
stop executing SCG addition on identifying that an SCG addition event is satisfied for an execution condition associated with CPA configuration in response to sending the MCG measurement report for an LTM event;
stop sending the measurement event of the LTM event identifying that the SCG addition event is satisfied for LTM SCG addition event in response to sending the MCG measurement report for the LTM event;
stop executing SCG addition on identifying that C-LTM event for SCG addition is satisfied in response to sending the MCG measurement report for the LTM event;
stop executing SCG addition on identifying that the SCG addition event is satisfied for the execution condition associated with the CPA configuration in response to sending the MCG measurement report for the LTM event until an expiry of a timer;
stop sending the measurement event of the LTM event identifying that the SCG addition event is satisfied for LTM SCG addition event in response to sending the MCG measurement report for the LTM event until the expiry of the timer; or
stop executing SCG addition on identifying that C-LTM event for SCG addition is satisfied in response to sending the MCG measurement report for the LTM event until the expiry of the timer.

14. The UE as claimed in claim 11, wherein the one or more computer programs, when executed by the at least one processor individually or collectively, cause the UE to:
stop measurement of at least one of the CPA, an LTM event or a C-LTM event for SCG addition until an expiry of a timer in response to sending the MCG measurement report for the LTM event on at least one of infinite or time bound and until the expiry of the timer.

15. The UE as claimed in claim 11, wherein the one or more computer programs, when executed by the at least one processor individually or collectively, cause the UE to:
perform measurement of at least one of the CPA, an LTM event or a C-LTM event for SCG addition and stop executing SCG addition on identifying that an SCG addition event is satisfied based on at least one of infinite or time bound and until expiry of a timer.

16. The UE as claimed in claim 11,
wherein the LTM configuration message indicates the handover of the UE to the second network entity associated with a target cell,
wherein the first network entity is associated with a source cell, and
wherein a first layer measurement report indicates that an LTM event has been satisfied to trigger the MCG cell change.

17. The UE as claimed in claim 11, wherein the LTM configuration message is received to perform the MCG cell change from the first network entity, wherein the first network entity configures at least one LTM measurement event for the MCG cell change.

18. The UE as claimed in claim 11, wherein a SCG addition event includes at least one of:
conditional PSCell addition (CPAC) event, LTM event for SCG addition, or C-LTM event for SCG addition.
